(19) United States
(12) Patent Application Publication
(10) Pub. No.: US 2023/0268547 A1
(43) Pub. Date: Aug. 24, 2023

(54) SOLID-STATE INTERLAYER FOR SOLID-STATE BATTERY

(71) Applicant: GM GLOBAL TECHNOLOGY OPERATIONS LLC, Detroit, MI (US)

(72) Inventors: Qili SU, Shanghai (CN); Zhe LI, Shanghai (CN); Xiaochao QUE, Shanghai (CN); Haijing LIU, Shanghai (CN)

(73) Assignee: GM GLOBAL TECHNOLOGY OPERATIONS LLC, Detroit, MI (US)

(21) Appl. No.: 17/828,898

(22) Filed: May 31, 2022

(30) Foreign Application Priority Data
Feb. 21, 2022 (CN) 202210156734.3

(51) Int. Cl. H01M 10/056; H01M 10/0525

(52) U.S. Cl. CPC H01M 10/056; H01M 10/0525; H01M 2220/20

(57) ABSTRACT

The present disclosure provides an electrochemical cell that cycles lithium ions, where the electrochemical cell includes an electrode, a solid-state electrolyte layer, and a solid-state interlayer disposed between the electrode and the solid-state electrolyte layer. The solid-state interlayer includes a plurality of solid-state electrolyte particles. In certain instances, the solid-state interlayer includes a plurality of through-holes dispersed therewithin. The through-holes have an average diameter between about 0.05 to about 100 micrometers. The solid-state interlay covers between about 50% and about 100% of a total surface area of the electrode. In each variation, solid-state interlayer has a thickness greater than or equal to about 0.1 to less than or equal to about 8 micrometers, and the electrochemical cell may include a polymeric gel electrolyte that at least partially fills voids between solid-state electroactive particle and solid-state electrolyte particles.

### CROSS-REFERENCE TO RELATED APPLICATIONS

This application claims the benefit and priority of Chinese Application No. 202210156734.3, filed Feb. 21, 2022. The entire disclosure of the above application is incorporated herein by reference.

### INTRODUCTION

This section provides background information related to the present disclosure which is not necessarily prior art.

Electrochemical energy storage devices, such as lithium-ion batteries, can be used in a variety of products, including automotive products such as start-stop systems (e.g., 12 V start-stop systems), battery-assisted systems (“µBAS”), Hybrid Electric Vehicles (“HEVs”), and Electric Vehicles (“EVs”). Typical lithium-ion batteries include two electrodes and an electrolyte component and/or separator. One of the two electrodes can serve as a positive electrode or cathode, and the other electrode can serve as a negative electrode or anode. Lithium-ion batteries may also include various terminal and packaging materials. Rechargeable lithium-ion batteries operate by reversibly passing lithium ions back and forth between the negative electrode and the positive electrode. For example, lithium ions may move from the positive electrode to the negative electrode during charging of the battery and in the opposite direction when discharging the battery. A separator and/or electrolyte may be disposed between the negative and positive electrodes. The electrolyte is suitable for conducting lithium ions between the electrodes and, like the two electrodes, may be in a solid form, a liquid form, or a solid-liquid hybrid form. In the instances of solid-state batteries, which includes a solid-state electrolyte layer disposed between solid-state electrodes, the solid-state electrolyte physically separates the solid-state electrodes so that a distinct separator is not required.

Free-standing solid-state electrolytes permit fast (e.g., greater than about 0.01 mS/cm) ion transportation at low temperatures (e.g., about - 18° C.) and enable a high cycle durability (e.g., at least 70 % capacity retention for more than about 500 cycles) at room temperature (e.g., about 25° C.), but often have poor oxidation stability at higher temperatures (e.g., greater than about 30° C.) and a micro-ampere level parasitic current during linear sweeping voltammetry as a result of the electrochemical instability of certain polymer functional group (e.g., CN-group) in the free-standing solid state electrolyte. Accordingly, it would be desirable to develop materials, and processes, for improving interfacial compatibilities between solid-state electrolyte layers and the adjacent electrodes.

### SUMMARY

This section provides a general summary of the disclosure, and is not a comprehensive disclosure of its full scope or all of its features.

The present disclosure relates to solid-state batteries and methods of forming the same. More particularly, the present disclosure relates to solid-state interlayers disposed between a solid-state electrolyte and one or more adjacent electrodes.

In various aspects, the present disclosure provides an electrochemical cell that cycles lithium ions, where the electrochemical cell includes an electrode, a solid-state electrolyte layer, and a solid-state interlayer disposed between the electrode and the solid-state electrolyte layer. The electrode may include a plurality of solid-state electroactive particles. The solid-state interlayer may include a plurality of first solid-state electrolyte particles. The solid-state interlayer may have a thickness greater than or equal to about 0.1 µm to less than or equal to about 8 µm.

In one aspect, the first solid-state electrolyte particles may be selected from the group consisting of: Li₁+ₓAlₓTi₂₋ₓ(PO₄)₃, where 0 ≤ x ≤ 2 (LATP Li₂+₂ₓZn₁-ₓGeO₄ (where 0 < x < 1), Li₁₄Zn(GeO₄)₄,), Li₇La₃Zr₂O₁₂, Li_{6.2}Ga_{0.3}La_{2.95}Rb_{0.05}Zr₂O₁₂, Li_{6.85}La_{2.9}Ca_{0.1}Zr_{1.75}Nb_{0.25}O₁₂, Li₂₊_{2X}Zn₁₋ₓGeO₄ (where 0 < x < 1), Li₁₄Zn(GeO₄)₄, Li_{3.3}La_{0.53}TiO₃, LiSr_{1.65}Zr_{1.3}Ta_{1.7}O₉, Li_{2x-y}Sr₁₋ₓTa_{y}Zr_{1-y}O₃ (where x = 0.75y and 0.60 < y < 0.75), Li₁+ₓA1ₓGe₂₋ₓ(PO₄)₃ (where 0 ≤ x ≤ 2) (LAGP), Li_{1.4}Al_{0.4}Ti_{1.6}(PO₄)₃, Li_{1.3}A_{0.3}Ti_{1.7}(PO₄)₃, LiTi₂(PO₄)₃, Li₃N, Li₇PN₄, LiSi₂N₃, LiI, Li₃InC1₆, Li₂CdCl₄, Li₂MgCl₄, LiCdI₄, Li₂ZnI₄, Li₃OCl, Li₃YCl₆, Li₃YBr₆, Li₂B₄O₇, Li₂O—B₂O₃—P₂O₅, and combinations thereof.

In one aspect, the electrode may include a plurality of second solid-state electrolyte particles.

In one aspect, the second solid-state electrolyte particles may be the same as the first electrolyte particles.

In one aspect, the solid-state electrolyte layer may include a plurality of second electrolyte particles, where the second electrolyte particles are different from the first electrolyte particles.

In one aspect, the solid-state electrolyte layer may further include a polymeric gel electrolyte. The polymeric gel electrolyte may at least partially fill voids between the second electrolyte particles.

In one aspect, the solid-state electrolyte layer may be a free-standing membrane defined by a polymeric gel. The free-standing membrane may have a thickness greater than or equal to about 5 µm to less than or equal to about 200 µm.

In one aspect, the electrochemical cell may further include a polymeric gel electrolyte. The polymeric gel electrolyte may at least partially fill voids between the solid-state electroactive particle.

In one aspect, the polymeric gel electrolyte may at least partially fill voids between the first solid-state electrolyte particles.

In one aspect, the solid-state interlayer may cover greater than or equal to about 50% to less than or equal to about 100% of a total surface area of a surface of the electrode opposing the solid-state electrolyte layer.

In one aspect, the solid-state interlayer may include a plurality of through-holes dispersed therewithin.

In one aspect, the through-holes may have an average diameter greater than or equal to about 0.05 µm to less than or equal to about 100 µm.

In one aspect, the solid-state interlayer may cover greater than or equal to about 50% to less than or equal to about 100% of a total surface area of a surface of the electrode opposing the solid-state electrolyte layer.

In various aspects, the present disclosure provides an electrochemical cell that cycles lithium ions, where the electrochemical cell includes a first electrode, a second electrode, a solid-state electrolyte layer disposed between the first electrode and the second electrode, and a solid-state interlayer disposed between the first electrode and the solid-state electrolyte layer. The first electrode may include a plurality of first solid-state electroactive particles. The second electrode may include a plurality of second solid-state electroactive particles. The solid-state interlayer may include a plurality of first solid-state electrolyte particles. The solid-state interlayer may have a thickness greater than or equal to about 0.1 µm to less than or equal to about 8 µm.

In one aspect, the solid-state interlayer may be a first solid-state interlayer, and the electrochemical cell may further include a second solid-state interlayer disposed between the second electrode and the solid-state electrolyte layer. The second solid-state interlayer may include a plurality of second solid-state electrolyte particles. The second solid-state may have a thickness greater than or equal to about 0.1 µm to less than or equal to about 8 µm.

In one aspect, the first and second solid-state electrolyte particles may be independently selected from the group consisting of: Li₁+ₓAlₓTi₂₋ₓ(PO₄)₃, where 0 ≤ x ≤ 2 (LATP Li₂₊₂ₓZn₁₋ₓGeO₄ (where 0 < x < 1), Li₁₄Zn(GeO₄)₄,), Li₇La₃Zr₂O₁₂, Li_{6.2}Ga_{0.3}La_{2.95}Rb_{0.05}Zr₂O₁₂, Li_{6.85}La_{2.9}Ca_{0.1}Zr_{1.75}Nb_{0.25}O₁₂, Li₂₊₂ₓZn₁₋ₓGeO₄ (where 0 < x < 1), Li₁₄Zn(GeO₄)₄, Li_{3.3}La_{0.53}TiO₃, LiSr_{1.65}Zr_{1.3}Ta₁.₇O₉, Li_{2x-y}Sr1₋ₓTa_{y}Zr_{1-y}O₃ (where x = 0.75y and 0.60 < y < 0.75), Li₁₊ₓAlₓGe₂₋ₓ(PO₄)₃ (where 0 ≤ x ≤ 2) (LAGP), Li_{1.4}Al_{0.4}Ti_{1.6}(PO₄)₃, Li_{1.3}Al_{0.3}Ti_{1.7}(PO₄)₃, LiTi₂(PO₄)₃, Li3N, Li₇PN₄, LiSi₂N₃, LiI, Li₃InC1₆, Li₂CdCl₄, Li₂MgCl₄, LiCdI₄, Li₂ZnI₄, Li₃OCl, Li₃YCl₆, Li₃YBr₆, Li₂B₄O₇, Li₂O—B₂O₃—P₂O₅, and combinations thereof.

In one aspect, the electrochemical cell may further include a polymeric gel system. The polymeric gel system may at least partially fill voids between the first solid-state electroactive particles, the first solid-state electrolyte particles, the second solid-state electroactive particles, and the second solid-state electrolyte particles.

In one aspect, the first solid-state interlayer may cover greater than or equal to about 50% to less than or equal to about 100% of a total surface area of a surface of the first electrode opposing the solid-state electrolyte layer, and the second solid-state interlayer may cover greater than or equal to about 50% to less than or equal to about 100% of a total surface area of a surface of the second electrode opposing the solid-state electrolyte layer.

In one aspect, at least one of the first and second solid-state interlayers may include a plurality of through-holes dispersed therewithin. The through-holes may have an average diameter greater than or equal to about 0.05 µm to less than or equal to about 100 µm.

In one aspect, the solid-state electrolyte layer may be a free-standing membrane. The free-standing membrane may be defined by a polymeric gel. The free-standing membrane may have a thickness greater than or equal to about 5 µm to less than or equal to about 200 µm.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1A is an illustration of an example solid-state battery in accordance with various aspects of the present disclosure;

FIG. 1B is an example solid-state battery having a polymeric gel electrolyte system in accordance with various aspects of the present disclosure;

FIG. 1C is an example solid-state battery having a solid-state interlayer in accordance with various aspects of the present disclosure;

FIG. 2 is another example solid-state battery having a polymeric gel electrolyte system and a solid-state interlayer having a plurality of through-holes in accordance with various aspects of the present disclosure;

FIG. 3 is another example solid-state battery having a free-standing electrolyte layer and a solid-state interlayer in accordance with various aspects of the present disclosure;

FIG. 4 is another example solid-state battery having a free-standing electrolyte layer and a solid-state interlayer in accordance with various aspects of the present disclosure;

FIG. 5A is a graphical illustration representing the thermal stability of an example battery cell prepared in accordance with various aspects of the present disclosure;

FIG. 5B is a graphical illustration representing the thermal stability of a comparative battery cell;

FIG. 6 is a graphical illustration representing the capacity retention of an example battery cell prepared in accordance with various aspects of the present disclosure;

FIG. 7 is a graphical illustration representing the direct current resistance (“DCR”) of the example battery cell prepared in accordance with various aspects of the present disclosure; and

FIG. 8 is a graphical illustration representing the starting, lighting, ignition (“SLI”) cranking after high temperature cycling of the example battery cell prepared in accordance with various aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature’s relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The current technology pertains to solid-state batteries (SSBs) and methods of forming and using the same. Solid-state batteries may include at least one solid component, for example, at least one solid electrode, but may also include, in certain variations, semi-solid or gel, liquid, or gas components. In various instances, solid-state batteries may have a bipolar stacking design comprising a plurality of bipolar electrodes where a first mixture of solid-state electroactive material particles (and optional solid-state electrolyte particles) is disposed on a first side of a current collector, and a second mixture of solid-state electroactive material particles (and optional solid-state electrolyte particles) is disposed on a second side of a current collector that is parallel with the first side. The first mixture may include, as the solid-state electroactive material particles, cathode material particles. The second mixture may include, as solid-state electroactive material particles, anode material particles. The solid-state electrolyte particles in each instance may be the same or different.

In other variations, the solid-state batteries may have a monopolar stacking design comprising a plurality of monopolar electrodes where a first mixture of solid-state electroactive material particles (and optional solid-state electrolyte particles) is disposed on both a first side and a second side of a first current collector, wherein the first and second sides of the first current collector are substantially parallel, and a second mixture of solid-state electroactive material particles (and optional solid-state electrolyte particles) is disposed on both a first side and a second side of a second current collector, where the first and second sides of the second current collector are substantially parallel. The first mixture may include, as the solid-state electroactive material particles, cathode material particles. The second mixture may include, as solid-state electroactive material particles, anode material particles. The solid-state electrolyte particles in each instance may be the same or different. In certain variations, solid-state batteries may include a mixture of combination of bipolar and monopolar stacking designs.

Such solid-state batteries may be incorporated into energy storage devices, like rechargeable lithium-ion batteries, which may be used in automotive transportation applications (e.g., motorcycles, boats, tractors, buses, mobile homes, campers, and tanks). The present technology, however, may also be used in other electrochemical devices, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. In various aspects, the present disclosure provides a rechargeable lithium-ion battery that exhibits high temperature tolerance, as well as improved safety and superior power capability and life performance.

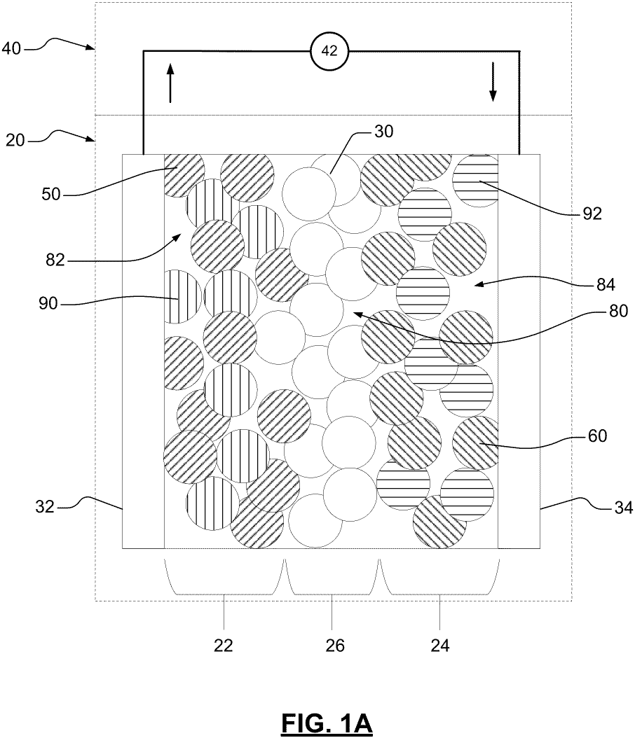

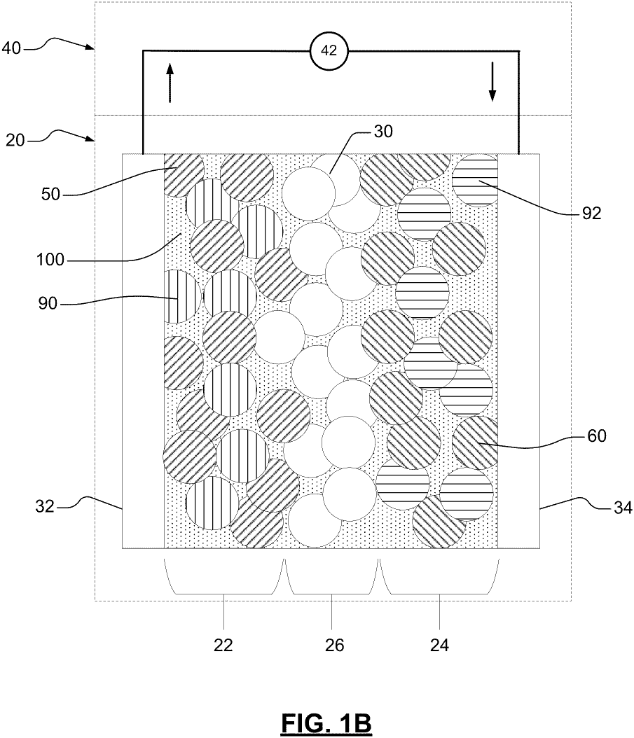

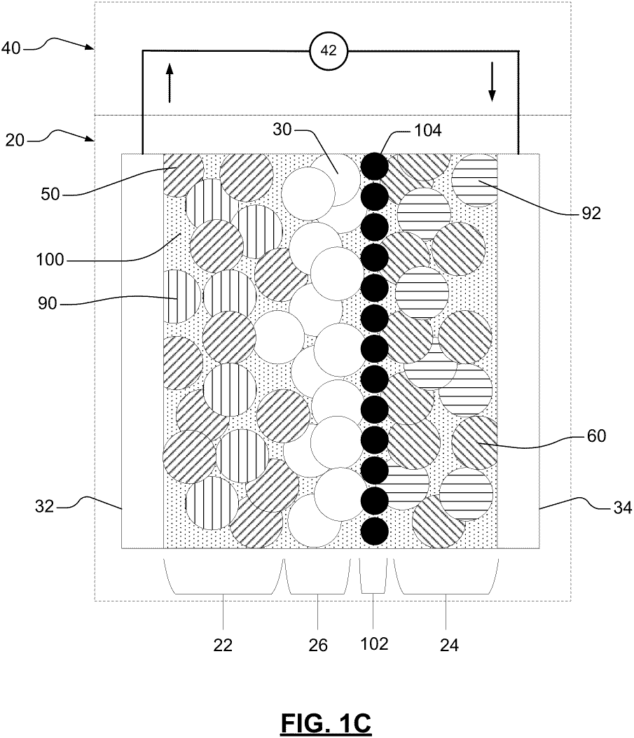

Exemplary and schematic illustrations of a solid-state electrochemical cell unit (also referred to as a “solid-state battery” and/or “semi-solid battery” and/or “semi-solid electrochemical cell unit” and/or “battery”) 20 that cycles lithium ions is shown in FIGS. 1A-1C. The battery 20 includes a negative electrode (i.e., anode) 22, a positive electrode (i. e., cathode) 24, and an electrolyte layer 26 that occupies a space between the two or more electrodes. The electrolyte layer 26 may be a solid-state or semi-solid state separating layer that physically separates the negative electrode 22 from the positive electrode 24. The electrolyte layer 26 may include a first plurality of solid-state electrolyte particles 30. A second plurality of solid-state electrolyte particles 90 may be mixed with negative solid-state electroactive particles 50 in the negative electrode 22, and a third plurality of solid-state electrolyte particles 92 may be mixed with positive solid-state electroactive particles 60 in the positive electrode 24, so as to form a continuous electrolyte network, which may be a continuous lithium-ion conduction network. The second plurality of solid-state electrolyte particles 90 may be the same as or different from the first plurality of solid-state electrolyte particles 30, and the third plurality of solid-state electrolyte particles 92 may be the same as or different from the second plurality of solid-state electrolyte particles 90.

A first current collector 32 may be positioned at or near the negative electrode 22. The first current collector 32 may be a metal foil, metal grid or screen, or expanded metal comprising copper or any other appropriate electrically conductive material known to those of skill in the art. A second current collector 34 may be positioned at or near the positive electrode 24. The second current collector 34 may be a metal foil, metal grid or screen, or expanded metal comprising aluminum or any other appropriate electrically conductive material known to those of skill in the art. The first current collector 32 and the second current collector 34 may be the same or different. The first current collector 32 and the second electrode current collector 34 respectively collect and move free electrons to and from an external circuit 40. For example, an interruptible external circuit 40 and a load device 42 may connect the negative electrode 22 (through the first current collector 32) and the positive electrode 24 (through the second current collector 34).

Although not illustrated, the skilled artisan will recognize that in certain variations, the first current collector 32 may be a first bipolar current collector and/or the second current collector 34 may be a second bipolar current collector. For example, the first bipolar current collector 34 and/or the second bipolar current collector 34 may be a cladded foil, for example, where one side (e.g., the first side or the second side) of the current collector 32, 34 includes one metal (e.g., first metal) and another side (e.g., the other side of the first side or the second side) of the current collector 32 includes another metal (e.g., second metal). The cladded foil may include, for example only, aluminum-copper (Al—Cu), nickel-copper (Ni—Cu), stainless steel-copper (SS—Cu), aluminum-nickel (Al—Ni), aluminum-stainless steel (Al—SS), and nickel-stainless steel (Ni—SS). In certain variations, the first bipolar current collector 32 and/or second bipolar current collectors 34 may be pre-coated, such as graphene or carbon-coated aluminum current collectors.

The battery 20 can generate an electric current (indicated by arrows in FIGS. 1A-1C) during discharge by way of reversible electrochemical reactions that occur when the external circuit 40 is closed (to connect the negative electrode 22 and the positive electrode 24) and when the negative electrode 22 has a lower potential than the positive electrode 24. The chemical potential difference between the negative electrode 22 and the positive electrode 24 drives electrons produced by a reaction, for example, the oxidation of intercalated lithium, at the negative electrode 22, through the external circuit 40 toward the positive electrode 24. Lithium ions, which are also produced at the negative electrode 22, are concurrently transferred through the electrolyte layer 26 toward the positive electrode 24. The electrons flow through the external circuit 40 and the lithium ions migrate across the electrolyte layer 26 to the positive electrode 24, where they may be plated, reacted, or intercalated. The electric current passing through the external circuit 40 can be harnessed and directed through the load device 42 (in the direction of the arrows) until the lithium in the negative electrode 22 is depleted and the capacity of the battery 20 is diminished.

The battery 20 can be charged or reenergized at any time by connecting an external power source (e.g., charging device) to the battery 20 to reverse the electrochemical reactions that occur during battery discharge. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator. The connection of the external power source to the battery 20 promotes a reaction, for example, non-spontaneous oxidation of intercalated lithium, at the positive electrode 24 so that electrons and lithium ions are produced. The electrons, which flow back toward the negative electrode 22 through the external circuit 40, and the lithium ions, which move across the electrolyte layer 26 back toward the negative electrode 22, reunite at the negative electrode 22 and replenish it with lithium for consumption during the next battery discharge cycle. As such, a complete discharging event followed by a complete charging event is considered to be a cycle, where lithium ions are cycled between the positive electrode 24 and the negative electrode 22.

Although the illustrated example includes a single positive electrode 24 and a single negative electrode 22, the skilled artisan will recognize that the current teachings apply to various other configurations, including those having one or more cathodes and one or more anodes, as well as various current collectors and current collector films with electroactive particle layers disposed on or adjacent to or embedded within one or more surfaces thereof. Likewise, it should be recognized that the battery 20 may include a variety of other components that, while not depicted here, are nonetheless known to those of skill in the art. For example, the battery 20 may include a casing, a gasket, terminal caps, and any other conventional components or materials that may be situated within the battery 20, including between or around the negative electrode 22, the positive electrode 24, and/or the electrolyte layer 26.

In many configurations, each of the negative electrode current collector 32, the negative electrode 22, the electrolyte layer 26, the positive electrode 24, and the positive electrode current collector 34 are prepared as relatively thin layers (for example, from several microns to a millimeter or less in thickness) and assembled in layers connected in series arrangement to provide a suitable electrical energy, battery voltage and power package, for example, to yield a Series-Connected Elementary Cell Core (“SECC”). In various other instances, the battery 20 may further include electrodes 22, 24 connected in parallel to provide suitable electrical energy, battery voltage, and power for example, to yield a Parallel-Connected Elementary Cell Core (“PECC”).

The size and shape of the battery 20 may vary depending on the particular applications for which it is designed. Battery-powered vehicles and hand-held consumer electronic devices are two examples where the battery 20 would most likely be designed to different size, capacity, voltage, energy, and power-output specifications. The battery 20 may also be connected in series or parallel with other similar lithium-ion cells or batteries to produce a greater voltage output, energy, and power if it is required by the load device 42. The battery 20 can generate an electric current to the load device 42 that can be operatively connected to the external circuit 40. The load device 42 may be fully or partially powered by the electric current passing through the external circuit 40 when the battery 20 is discharging. While the load device 42 may be any number of known electrically-powered devices, a few specific examples of power-consuming load devices include an electric motor for a hybrid vehicle or an all-electric vehicle, a laptop computer, a tablet computer, a cellular phone, and cordless power tools or appliances, by way of non-limiting example. The load device 42 may also be an electricity-generating apparatus that charges the battery 20 for purposes of storing electrical energy.

With renewed reference to FIGS. 1A-1C, the electrolyte layer 26, which may be a semi-solid, provides electrical separation—preventing physical contact— between the negative electrode 22 and the positive electrode 24. The electrolyte layer 26 also provides a minimal resistance path for internal passage of ions. In various aspects, the electrolyte layer 26 may be defined by a first plurality of solid-state electrolyte particles 30. For example, the electrolyte layer 26 may be in the form of a layer or a composite that comprises the first plurality of solid-state electrolyte particles 30.

In certain variations, the electrolyte layer 26 may be in the form of a layer having an average thickness greater than or equal to about 1 µm to less than or equal to about 1,000 µm, optionally greater than or equal to about 5 µm to less than or equal to about 200 µm, optionally greater than or equal to about 10 µm to less than or equal to about 100 µm, optionally about 20 µm, and in certain aspects, optionally about 15 µm. The electrolyte layer 26 may be in the form of a layer having an average thickness greater than or equal to 1 µm to less than or equal to 1,000 µm, optionally greater than or equal to 5 µm to less than or equal to 200 µm, optionally greater than or equal to 10 µm to less than or equal to 100 µm, optionally 20 µm, and in certain aspects, optionally 15 µm.

As illustrated in FIG. 1A, the electrolyte layer 26 may have an interparticle porosity 80 between the solid-state electrolyte particles 30 that is greater than 0 vol.% to less than or equal to about 50 vol.%, optionally greater than or equal to about 1 vol.% to less than or equal to about 40 vol.%, and in certain aspects, optionally greater than or equal to about 2 vol.% to less than or equal to about 20 vol.%. The electrolyte layer 26 may have an interparticle porosity 80 between the solid-state electrolyte particles 30 that is greater than 0 vol.% to less than or equal to 50 vol.%, optionally greater than or equal to 1 vol.% to less than or equal to 40 vol.%, and in certain aspects, optionally greater than or equal to 2 vol.% to less than or equal to 20 vol.%.

In certain variations, the solid-state electrolyte particles 30 may have an average particle diameter greater than or equal to about 0.02 µm to less than or equal to about 20 µm, optionally greater than or equal to about 0.1 µm to less than or equal to about 10 µm, and in certain aspects, optionally greater than or equal to about 0.1 µm to less than or equal to about 5 µm. The solid-state electrolyte particles 30 may have an average particle diameter greater than or equal to 0.02 µm to less than or equal to 20 µm, optionally greater than or equal to 0.1 µm to less than or equal to 10 µm, and in certain aspects, optionally greater than or equal to 0.1 µm to less than or equal to 5 µm. For example, the solid-state electrolyte particles 30 may comprise one or more sulfide-based particles, oxide-based particles, metal-doped or aliovalent-substituted oxide particles, inactive oxide particles, nitride-based particles, hydride-based particles, halide-based particles, and borate-based particles.

In certain variations, the sulfide-based particles may include, for example only, a pseudobinary sulfide, a pseudoternary sulfide, and/or a pseudoquaternary sulfide. Example pseudobinary sulfide systems include Li₂S-P₂S₅ systems (such as, Li₃PS₄, Li₇P₃S₁₁, and Li_{9.6}P₃S₁₂), Li₂S—SnS₂ systems (such as, Li₄SnS₄), Li₂S—SiS₂ systems, Li₂S—GeS₂ systems, Li₂S—B₂S₃ systems, Li₂S—Ga₂S₃ system, Li₂S—P₂S₃ systems, and Li₂S—Al₂S₃ systems. Example pseudoternary sulfide systems include Li₂O—Li₂S—P₂S₅ systems, Li₂S—P₂S₅—P₂O₅ systems, Li₂S—P₂S₅—GeS₂ systems (such as, Li_{3.25}Ge_{0.25}P_{0.75}S₄ and Li₁₀GeP₂S₁₂), Li₂S—P₂S₅—LiX systems (where X is one of F, Cl, Br, and I) (such as, Li₆PS₅Br, Li₆PS₅Cl, L₇P₂S₈I, and Li₄PS₄I), Li₂S—As₂S₅—SnS₂ systems (such as, Li_{3.833}Sn₀.₈₃₃As_{0.166}S₄), Li₂S—P₂S₅—Al₂S₃ systems, Li₂S—LiX—SiS₂ systems (where X is one of F, Cl, Br, and I), 0.4LiI·0.6Li₄SnS₄, and Li₁₁S₁₂PS₁₂. Example pseudoquaternary sulfide systems include Li₂O—Li₂S—P₂S₅₋P₂O₅ systems, Li_{9.54}Si_{1.74}P_{1.44}S_{11.7}Cl_{0.3}, Li₇P_{2.9}Mn_{0.1}S_{10.7}I_{0.3}, and Li_{10.35}[Sn_{0.27}Si_{1.08}]P_{1.65}S_{12.}

In certain variations, the oxide-based particles may comprise one or more garnet ceramics, LISICON-type oxides, NASICON-type oxides, and Perovskite type ceramics. For example, the garnet ceramics may be selected from the group consisting of: Li₇La₃Zr₂O₁₂, Li_{6.2}Ga_{0.3}La_{2.95}Rb_{0.05}Zr₂O₁₂, Li_{6.85}La_{2.9}Ca_{0.1}Zr₁.₇₅Nb_{0.25}O₁₂, Li_{6.25}Al_{0.25}La₃Zr₂O₁₂, Li_{6.75}La₃Zri_{.75}Nb_{O.25}O₁₂, and combinations thereof. The LISICON-type oxides may be selected from the group consisting of: Li₂₊₂ₓZn₁₋ₓGeO₄ (where 0 < x < 1), Li₁₄Zn(GeO₄)₄, Li₃+ₓ(P₁₋ₓSiₓ)O₄ (where 0 < x < 1), Li₃₊ₓGeₓV₁₋ₓO₄ (where 0 < x < 1), and combinations thereof. The NASICON-type oxides may be defined by LiMM′(PO₄)₃, where M and M′ are independently selected from Al, Ge, Ti, Sn, Hf, Zr, and La. For example, in certain variations, the NASICON-type oxides may be selected from the group consisting of: Li₁+ₓAlₓGe₂₋ₓ(PO₄)₃ (where 0 < x < 2) (LAGP), Li₁.₄Al_{0.4}Ti_{1.6}(PO₄)₃, Li_{1.3}Al_{0.3}Ti_{1.7}(PO₄)₃, LiTi₂(PO₄)₃, LiGeTi(PO₄)₃, LiGe₂(PO₄)₃, LiHf₂(PO₄)₃, and combinations thereof. The Perovskite-type ceramics may be selected from the group consisting of: Li_{3.3}La_{0.53}TiO₃, LiSr_{1.65}Zr_{1.3}Ta_{1.}7O₉, Li_{2x-y}Sr₁₋ₓTa_{y}Zr_{1-y}O₃ (where x = 0.75y and 0.60 < y < 0.75), Li_{⅜}Sr_{7/16}Nb_{¾}Zr_{¼}O₃, Li₃ₓLa(_{⅔-x})TiO₃ (where 0 < x < 0.25), and combinations thereof.

In certain variations, the metal-doped or aliovalent-substituted oxide particles may include, for example only, aluminum (Al) or niobium (Nb) doped Li₇La₃Zr₂O₁₂, antimony (Sb) doped Li₇La₃Zr₂O₁₂, gallium (Ga) doped Li₇La₃Zr₂O₁₂, chromium (Cr) and/or vanadium (V) substituted LiSn₂P₃O₁₂, aluminum (Al) substituted Li_{1+x+y}AlₓTi₂₋ₓSi_{Y}P_{3-y}O₁₂ (where 0 < x < 2 and 0 < y < 3), and combinations thereof.

In certain variations, the inactive oxide particles may include, for example only, SiO₂, Al₂O₃, TiOz, ZrO₂, and combinations thereof; the nitride-based particles may include, for example only, Li3N, Li₇PN₄, LiSi₂N₃, and combinations thereof; the hydride-based particles may include, for example only, LiBH₄, LiBH₄-LiX (where X = Cl, Br, or I), LiNH₂, Li₂NH, LiBH₄—LiNH₂, Li₃AlH₆, and combinations thereof; the halide-based particles may include, for example only, LiI, Li₃InCl₆, Li₂CdCl₄, Li₂MgCl₄, LiCdI₄, Li₂ZnI₄, Li₃OCl, Li₃YCl₆, Li₃YBr₆, and combinations thereof; and the borate-based particles may include, for example only, Li₂B₄O₇, Li₂O—B₂O₃—P₂O₅, and combinations thereof.

In various aspects, the first plurality of solid-state electrolyte particles 30 may include one or more electrolyte materials selected from the group consisting of: Li₂S—P₂S₅ system, Li₂S—P₂S₅—MOₓ system (where 1 < x < 7), Li₂S—P₂S₅—MSstem (where 1 < x < 7), Li₁₀GeP₂S₁₂ (LGPS), Li₆PS₅X (where X is Cl, Br, or I) (lithium argyrodite), Li₇P₂S₈I, Li_{10.35}Ge₁.₃₅P₁.₆₅S₁₂, Li_{3.25}Ge_{0.25}P_{0.75}S₄ (thio-LISICON), Li₁₀SnP₂S₁₂, Li₁₀SiP₂S₁₂, Li_{9.54}Si_{1.74}P_{1.44}S_{11.7}Cl_{0.3}, (1-x)P₂S₅-xLi₂S (where 0.5 ≤ x ≤ 0.7), Li_{3.4}Si_{0.4}P_{0.6}S₄, PLi₁₀GeP₂S_{11.7}O_{0.3}, Li_{9.6}P₃S₁₂, Li₇P₃S₁₁, Li₉P₃S₉O₃, Li_{10.35}Ge_{1.35}P_{1.63}S₁₂, Li_{9.81}Sn_{0.81}P_{2.19}S₁₂, Li₁₀(Si_{0.5}Geo_{.5})P₂S₁₂, Li₁₀₍Ge_{0.5}Sn_{0.5})P₂S₁₂, Li₁₀(Si_{0.5}Sn_{0.5})P₂S₁₂, Li_{3.833}Sn_{0.833}As_{0.16}S₄, Li₇La₃Zr₂O₁₂, Li_{6.2}Ga_{0.3}La_{2.95}Rb_{0.05}Zr₂O₁₂, Li_{6.85}La_{2.g}Ca_{0.1}Zr_{1.75}Nb_{0.25}O₁₂, Li_{6.25}Al_{0.25}La₃Zr₂O₁₂, Li_{6.75}La₃Zr_{1.75}Nb_{0.25}O₁₂, Li_{6.75}La₃Zr_{1.75}Nb_{0.25}O₁₂, Li₂₊₂ₓZn₁₋ₓGeO₄ (where 0 < x < 1), Li₁₄Zn(GeO₄)₄, Li₃₊ₓ(P₁₋ₓSiₓ)O₄ (where 0 < x < 1), Li₃₊ₓGeₓV₁₋ₓO₄ (where 0 < x < 1), LiMM′(PO₄)₃ (where M and M′ are independently selected from Al, Ge, Ti, Sn, Hf, Zr, and La), Li_{3.3}La_{0.53}TiO₃, LiSr_{1.65}Zr_{1.3}Ta_{1.7}O₉, Li_{2x-y}Sr₁₋ₓTa_{y}Zr_{1-y}O₃ (where x = 0.75y and 0.60 < y < 0.75), Li_{⅜}Sr_{7/16}Nb_{¾}Zr_{¼}O₃, Li₃ₓLa(_{⅔-x})TiO₃ (where 0 < x < 0.25), aluminum (Al) or niobium (Nb) doped Li₇La₃Zr₂O₁₂, antimony (Sb) doped Li₇La₃Zr₂O₁₂, gallium (Ga) doped Li₇La₃Zr₂O₁₂, chromium (Cr) and/or vanadium (V) substituted LiSn₂P₃O₁₂, aluminum (Al) substituted Li_{1+x+y}AlₓTi₂₋ₓSi_{Y}P_{3-y}O₁₂ (where 0 < x < 2 and 0 < y < 3), LiI—Li₄SnS₄, Li₄SnS₄, Li₃N, Li₇PN₄, LiSi₂N₃, LiBH₄, LiBH₄—LiX (where x = Cl, Br, or I), LiNH₂, Li₂NH, LiBH₄—LiNH₂, Li₃AlH₆, LiI, Li₃InCl₆, Li₂CdC₁₄, Li₂MgCl₄, LiCdI₄, Li₂ZnI₄, Li₃OCl, Li₂B₄O₇, Li₂O—B₂O₃₋P₂O₅, and combinations thereof.

Although not illustrated, the skilled artisan will recognize that in certain instances, one or more binder particles may be mixed with the solid-state electrolyte particles 30. For example, in certain aspects, the electrolyte layer 26 may include greater than or equal to 0 wt.% to less than or equal to about 10 wt.%, and in certain aspects, optionally greater than or equal to about 0.5 wt.% to less than or equal to about 10 wt.%, of the one or more binders. The electrolyte layer 26 may include greater than or equal to 0 wt.% to less than or equal to 10 wt.%, and in certain aspects, optionally greater than or equal to 0.5 wt.% to less than or equal to 10 wt.%, of the one or more binders. The one or more polymeric binders may include, for example only, polyvinylidene difluoride (PVDF), polytetrafluoroethylene (PTFE), ethylene propylene diene monomer (EPDM) rubber, nitrile butadiene rubber (NBR), styrene-butadiene rubber (SBR), and lithium polyacrylate (LiPAA).

The negative electrode 22 may be formed from a lithium host material that is capable of functioning as a negative terminal of a lithium-ion battery. For example, in certain variations, the negative electrode 22 may be defined by a plurality of the negative solid-state electroactive particles 50. In certain instances, as illustrated, the negative electrode 22 is a composite comprising a mixture of the negative solid-state electroactive particles 50 and the second plurality of solid-state electrolyte particles 90. In each variation, the negative electrode 22 may be in the form of a layer having an average thickness greater than or equal to about 1 µm to less than or equal to about 1,000 µm, optionally greater than or equal to about 5 µm to less than or equal to about 400 µm, and in certain aspects, optionally greater than or equal to about 10 µm to less than or equal to about 300 µm.The negative electrode 22 may be in the form of a layer having an average thickness greater than or equal to 1 µm to less than or equal to 1,000 µm, optionally greater than or equal to 5 µm to less than or equal to 400 µm, and in certain aspects, optionally greater than or equal to 10 µm to less than or equal to 300 µm.

The negative electrode 22 may include greater than or equal to about 30 wt.% to less than or equal to about 98 wt.%, and in certain aspects, optionally greater than or equal to about 50 wt.% to less than or equal to about 95 wt.%, of the negative solid-state electroactive particles 50, and greater than or equal to 0 wt.% to less than or equal to about 50 wt.%, and in certain aspects, optionally greater than or equal to about 5 wt.% to less than or equal to about 20 wt.%, of the second plurality of solid-state electrolyte particles 90. The negative electrode 22 may include greater than or equal to 30 wt.% to less than or equal to 98 wt.%, and in certain aspects, optionally greater than or equal to 50 wt.% to less than or equal to 95 wt.%, of the negative solid-state electroactive particles 50, and greater than or equal to 0 wt.% to less than or equal to 50 wt.%, and in certain aspects, optionally greater than or equal to 5 wt.% to less than or equal to 20 wt.%, of the second plurality of solid-state electrolyte particles 90. The second plurality of solid-state electrolyte particles 90 may be the same as or different from the first plurality of solid-state electrolyte particles 30.

The negative solid-state electroactive particles 50 may be lithium-based, for example, a lithium alloy or lithium metal. In other variations, the negative solid-state electroactive particles 50 may be silicon-based comprising, for example, a silicon alloy and/or silicon-graphite mixture. In still other variations, the negative electrode 22 may be a carbonaceous anode and the negative solid-state electroactive particles 50 may comprise one or more negative electroactive materials, such as graphite, graphene, hard carbon, soft carbon, and carbon nanotubes (CNTs). In still further variations, the negative electrode 22 may comprise one or more negative electroactive materials, such as lithium titanium oxide (Li₄Ti₅O₁₂); one or more metal oxides, such as TiO₂ and/or V₂O₅; metal sulfides, such as FeS; and/or transition-metal electroactive materials, such as tin (Sn). The negative solid-state electroactive particles 50 may be selected from the group including, for example only, lithium, graphite, graphene, hard carbon, soft carbon, carbon nanotubes, silicon, silicon-containing alloys, tin-containing alloys, and/or other lithium-accepting materials.

In certain variations, the negative solid-state electroactive particles 50 may have an average particle diameter greater than or equal to about 0.01 µm to less than or equal to about 50 µm, and in certain aspects, optionally greater than or equal to about 1 µm to less than or equal to about 20 µm. The negative solid-state electroactive particles 50 may have an average particle diameter greater than or equal to 0.01 µm to less than or equal to 50 µm, and in certain aspects, optionally greater than or equal to 1 µm to less than or equal to 20 µm.

Although not illustrated, in certain variations, the negative electrode 22 may include one or more conductive additives and/or binder materials. For example, the negative solid-state electroactive particles 50 (and/or optional second plurality of solid-state electrolyte particles 90) may be optionally intermingled with one or more electrically conductive materials (not shown) that provide an electron conduction path and/or at least one polymeric binder material (not shown) that improves the structural integrity of the negative electrode 22.

For example, the negative solid-state electroactive particles 50 (and/or second plurality of solid-state electrolyte particles 90 (and/or optional second plurality of solid-state electrolyte particles 90) may be optionally intermingled with binders, such as polyvinylidene difluoride (PVDF), poly(vinylidene fluoride-co-hexafluoropropylene (PVDF-HFP), polytetrafluoroethylene (PTFE), sodium carboxymethyl cellulose (CMC), ethylene propylene diene monomer (EPDM) rubber, nitrile butadiene rubber (NBR), styrene-butadiene rubber (SBR), styrene ethylene butylene styrene copolymers (SEBS), styrene butadiene styrene copolymers (SBS), polyethylene glycol (PEO), and/or lithium polyacrylate (LiPAA) binders. Electrically conductive materials may include, for example, carbon-based materials or a conductive polymer. Carbon-based materials may include, for example, particles of graphite, acetylene black (such as, KETCHEN™ black or DENKA™ black), carbon fibers and nanotubes, graphene (such as, graphene oxide), carbon black (such as, Super P), and the like. Examples of a conductive polymer may include polyaniline, polythiophene, polyacetylene, polypyrrole, and the like. In certain aspects, mixtures of the conductive additives and/or binder materials may be used.

The negative electrode 22 may include greater than or equal to 0 wt.% to less than or equal to about 30 wt.%, and in certain aspects, optionally greater than or equal to about 2 wt.% to less than or equal to about 10 wt.%, of the one or more electrically conductive additives; and greater than or equal to 0 wt.% to less than or equal to about 20 wt.%, and in certain aspects, optionally greater than or equal to about 1 wt.% to less than or equal to about 10 wt.%, of the one or more binders. The negative electrode 22 may include greater than or equal to 0 wt.% to less than or equal to 30 wt.%, and in certain aspects, optionally greater than or equal to 2 wt.% to less than or equal to 10 wt.%, of the one or more electrically conductive additives; and greater than or equal to 0 wt.% to less than or equal to 20 wt.%, and in certain aspects, optionally greater than or equal to 1 wt.% to less than or equal to 10 wt.%, of the one or more binders.

In various aspects, the negative electrode 22 may have an interparticle porosity 82 between the negative solid-state electroactive particles 50 and/or the solid-state electrolyte particles 90 (and optionally the one or more conductive additives and/or binder materials) that is greater than or equal to 0 vol.% to less than or equal to about 50 vol.%, and in certain aspects, optionally greater than or equal to about 2 vol.% to less than or equal to about 20 vol.%. The negative electrode 22 may have an interparticle porosity 82 between the negative solid-state electroactive particles 50 and/or the solid-state electrolyte particles 90 that is greater than or equal to 0 vol.% to less than or equal to 50 vol.%, and in certain aspects, optionally greater than or equal to 2 vol.% to less than or equal to 20 vol.%.

The positive electrode 24 may be formed from a lithium-based or electroactive material that can undergo lithium intercalation and deintercalation while functioning as the positive terminal of the battery 20. For example, in certain variations, the positive electrode 24 may be defined by a plurality of the positive solid-state electroactive particles 60. In certain instances, as illustrated, the positive electrode 24 is a composite comprising a mixture of the positive solid-state electroactive particles 60 and the third plurality of solid-state electrolyte particles 92. In each variation, the positive electrode 24 may be in the form of a layer having an average thickness greater than or equal to about 1 µm to less than or equal to about 1,000 µm, optionally greater than or equal to about 5 µm to less than or equal to about 400 µm, and in certain aspects, optionally greater than or equal to about 10 µm to less than or equal to about 300 µm. The positive electrode 24 may be in the form of a layer having an average thickness greater than or equal to 1 µm to less than or equal to 1,000 pm, optionally greater than or equal to 5 µm to less than or equal to 400 µm, and in certain aspects, optionally greater than or equal to 10 µm to less than or equal to 300 µm

The positive electrode 24 may include greater than or equal to about 30 wt.% to less than or equal to about 98 wt.%, and in certain aspects, optionally greater than or equal to about 50 wt.% to less than or equal to about 95 wt.%, of the positive solid-state electroactive particles 60, and greater than or equal to 0 wt.% to less than or equal to about 70 wt.%, optionally greater than or equal to 0 wt.% to less than or equal to about 50 wt.%, and in certain aspects, optionally greater than or equal to about 5 wt.% to less than or equal to about 20 wt.%, of the third plurality of solid-state electrolyte particles 92. The positive electrode 24 may include greater than or equal to 30 wt.% to less than or equal to 98 wt.%, and in certain aspects, optionally greater than or equal to 50 wt.% to less than or equal to 95 wt.%, of the positive solid-state electroactive particles 60, and greater than or equal to 0 wt.% to less than or equal to 70 wt.%, optionally greater than or equal to 0 wt.% to less than or equal to 50 wt.%, and in certain aspects, optionally greater than or equal to 5 wt.% to less than or equal to 20 wt.%, of the third plurality of solid-state electrolyte particles 92. The third plurality of solid-state electrolyte particles 92 may be the same as or different from the first and/or second pluralities of solid-state electrolyte particles 30, 90.

In certain variations, the positive electrode 24 may be one of a layered-oxide cathode, a spinel cathode, and a polyanion cathode. For example, in the instances of a layered-oxide cathode (e.g., rock salt layered oxides), the positive solid-state electroactive particles 60 may comprise one or more positive electroactive materials selected from LiCoO₂, LiNiₓMn_{y}Co_{1-x-y}O₂ (where 0 ≤ x ≤ 1 and 0 ≤ y ≤ 1), LiNiₓMn_{y}Al_{1-x-y}O₂ (where 0 < x ≤ 1 and 0 < y ≤ 1), LiNiₓMn₁₋ₓO₂ (where 0 ≤ x ≤ 1), and Li₁₊ₓMO₂ (where 0 ≤ x ≤ 1) for solid-state lithium-ion batteries. The spinel cathode may include one or more positive electroactive materials, such as LiMn₂O₄ and LiNi_{0.5}Mn_{1.5}O₄. The polyanion cation may include, for example, a phosphate, such as LiFePO₄, LiVPO₄, LiV₂(PO₄)₃, Li₂FePO₄F, Li₃Fe₃(PO₄)₄, or Li₃V₂(PO₄)F₃ for lithium-ion batteries, and/or a silicate, such as LiFeSiO₄ for lithium-ion batteries. In this fashion, in various aspects, the positive solid-state electroactive particles 60 may comprise one or more positive electroactive materials selected from the group consisting of LiCoO₂, LiNiₓMn_{y}Co_{1-x-y}O₂ (where 0 ≤ x ≤ 1 and 0 ≤ y ≤ 1), LiNiₓMn₁₋ₓO₂ (where 0 < x ≤ 1), Li₁₊ₓMO₂ (where 0 ≤ x < 1), LiMn₂O₄, LiNiₓMm_{.5}O₄, LiFePO₄, LiVPO₄, LiV₂(PO₄)₃, Li₂FePO₄F, Li₃Fe₃(PO₄)₄, Li₃V₂(PO₄)F₃, LiFeSiO₄, and combinations thereof. In certain aspects, the positive solid-state electroactive particles 60 may be coated (for example, by LiNbO₃ and/or Al₂O₃) and/or the positive electroactive material may be doped (for example, by aluminum and/or magnesium).

In certain variations, the positive solid-state electroactive particles 60 may have an average particle diameter greater than or equal to about 0.01 µm to less than or equal to about 50 µm, and in certain aspects, optionally greater than or equal to about 1 µm to less than or equal to about 20 µm. The positive solid-state electroactive particles 60 may have an average particle diameter greater than or equal to 0.01 µm to less than or equal to 50 µm, and in certain aspects, optionally greater than or equal to 1 µm to less than or equal to 20 µm.

Although not illustrated, in certain variations, the positive electrode 24 may further include one or more conductive additives and/or binder materials. For example, the positive solid-state electroactive particles 60 (and/or third plurality of solid-state electrolyte particles 92) may be optionally intermingled with one or more electrically conductive materials (not shown) that provide an electron conduction path and/or at least one polymeric binder material (not shown) that improves the structural integrity of the positive electrode 24.

For example, the positive solid-state electroactive particles 60 (and/or third plurality of solid-state electrolyte particles 92) may be optionally intermingled with binders, like polyvinylidene difluoride (PVDF), poly(vinylidene fluoride-co-hexafluoropropylene (PVDF-HFP), polytetrafluoroethylene (PTFE), sodium carboxymethyl cellulose (CMC), ethylene propylene diene monomer (EPDM) rubber, nitrile butadiene rubber (NBR), styrene-butadiene rubber (SBR), styrene ethylene butylene styrene copolymers (SEBS), styrene butadiene styrene copolymers (SBS), polyethylene glycol (PEO), and/or lithium polyacrylate (LiPAA) binders. Electrically conductive materials may include, for example, carbon-based materials or a conductive polymer. Carbon-based materials may include, for example, particles of graphite, acetylene black (such as, KETCHEN™ black or DENKA™ black), carbon fibers and nanotubes, graphene (such as, graphene oxide), carbon black (such as, Super P), and the like. Examples of a conductive polymer may include polyaniline, polythiophene, polyacetylene, polypyrrole, and the like. In certain aspects, mixtures of the conductive additives and/or binder materials may be used.

The positive electrode 24 may include greater than or equal to 0 wt.% to less than or equal to about 30 wt.%, and in certain aspects, optionally greater than or equal to about 2 wt.% to less than or equal to about 10 wt.%, of the one or more electrically conductive additives; and greater than or equal to 0 wt.% to less than or equal to about 20 wt.%, and in certain aspects, optionally greater than or equal to about 1 wt.% to less than or equal to about 10 wt.%, of the one or more binders. The positive electrode 24 may include greater than or equal to 0 wt.% to less than or equal to 30 wt.%, and in certain aspects, optionally greater than or equal to 2 wt.% to less than or equal to 10 wt.%, of the one or more electrically conductive additives; and greater than or equal to 0 wt.% to less than or equal to 20 wt.%, and in certain aspects, optionally greater than or equal to 1 wt.% to less than or equal to 10 wt.%, of the one or more binders.

In various aspects, the positive electrode 24 may have an interparticle porosity 84 between the positive solid-state electroactive particles 60 and/or the solid-state electrolyte particles 92 (and optionally the one or more conductive additives and/or binder materials) that is greater than or equal to 0 vol.% to less than or equal to about 50 vol.%, and in certain aspects, optionally greater than or equal to about 2 vol.% to less than or equal to about 20 vol.%. The positive electrode 24 may have an interparticle porosity 84 between the positive solid-state electroactive particles 60 and/or the solid-state electrolyte particles 92 that is greater than or equal to 0 vol.% to less than or equal to 50 vol.%, and in certain aspects, optionally greater than or equal to 2 vol.% to less than or equal to 20 vol.%.

As illustrated in FIG. 1A, direct contact between the solid-state electroactive particles 50, 60 and/or the solid-state electrolyte particles 30, 90, 92 (and/or optionally the one or more conductive additives and/or binder materials) may be much lower than the contact between a liquid electrolyte and solid-state electroactive particles in comparable non-solid-state batteries. For example, as illustrated in FIG. 1A, a battery 20 in green form may have an overall interparticle porosity that is greater than or equal to about 5 vol.% to less than or equal to about 40 vol.%, and in certain aspects, optionally greater than or equal to about 10 vol.% to less than or equal to about 40 vol.%. A battery 20 in green form may have an overall interparticle porosity that is greater than or equal to 5 vol.% to less than or equal to 40 vol.%, and in certain aspects, optionally greater than or equal to 10 vol.% to less than or equal to 40 vol.%.

In certain variations, a polymeric gel electrolyte (e.g., a semi-solid electrolyte) may be disposed within a solid-state battery so as to wet interfaces and/or fill void spaces between the solid-state electrolyte particles and/or the solid-state active material particles. For example, as illustrated in FIG. 1B, a polymeric gel electrolyte system 100 may be disposed within the battery 20 between the solid-state electrolyte particles 30, 90, 92 and/or the solid-state electroactive particles 50, 60, so as to, for example only, reduce interparticle porosity 80, 82, 84 and improve ionic contact and/or enable higher power capability. In certain variations, the battery 20 may include greater than or equal to about 0.5 wt.% to less than or equal to about 50 wt.%, and in certain aspects, optionally greater than or equal to about 5 wt.% to less than or equal to about 35 wt.%, of the polymeric gel electrolyte system 100. The battery 20 may include greater than or equal to 0.5 wt.% to less than or equal to 50 wt.%, and in certain aspects, optionally greater than or equal to 5 wt.% to less than or equal to 35 wt.%, of the polymeric gel electrolyte system 100.

Although it appears that there are no pores or voids remaining in the illustrated figure, the skilled artisan will recognize that some porosity may remain between adjacent particles (including, for example only, between the solid-state electroactive particles 50 and/or the solid-state electrolyte particles 90 and/or the solid-state electrolyte particles 30, and between the solid-state electroactive particles 60 and/or the solid-state electrolyte particles 92 and/or the solid-state electrolyte particles 30) depending on the penetration of the polymeric gel electrolyte system 100. For example, a battery 20 including the polymeric gel electrolyte system 100 may have a porosity less than or equal to about 30 vol.%, and in certain aspects, optionally less than or equal to about 10 vol.%. A battery 20 including the polymeric gel electrolyte system 100 may have a porosity less than or equal to 30 vol.%, and in certain aspects, optionally less than or equal to 10 vol.%.

In various aspects, the polymeric gel electrolyte system 100 includes a polymeric host and a liquid electrolyte. For example, the polymeric gel electrolyte system 100 may include greater than or equal to about 0.1 wt.% to less than or equal to about 50 wt.%, and in certain aspects, optionally greater than or equal to about 0.1 wt.% to less than or equal to about 10 wt.%, of the polymeric host, and greater than or equal to about 5 wt.% to less than or equal to about 99 wt.%, and in certain aspects, optionally greater than or equal to about 50 wt.% to less than or equal to about 95 wt.%, of the liquid electrolyte. The polymeric gel electrolyte system 100 may include greater than or equal to 0.1 wt.% to less than or equal to 50 wt.%, and in certain aspects, optionally greater than or equal to 0.1 wt.% to less than or equal to 10 wt.%, of the polymeric host, and greater than or equal to 5 wt.% to less than or equal to 99 wt.%, and in certain aspects, optionally greater than or equal to 50 wt.% to less than or equal to 95 wt.%, of the liquid electrolyte.

In certain variations, the polymeric host may be selected from the group consisting of: polyvinylidene fluoride (PVDF), polyvinylidene fluoride-hexafluoropropylene (PVDF-HFP), polyethylene oxide (PEO), polypropylene oxide (PPO), polyacrylonitrile (PAN), polymethacrylonitrile (PMAN), polymethyl methacrylate (PMMA), carboxymethyl cellulose (CMC), poly(vinyl alcohol) (PVA), polyvinylpyrrolidone (PVP), and combinations thereof.

The liquid electrolyte may include a lithium salt and a solvent. For example, the liquid electrolyte may include greater than or equal to about 5 wt.% to less than or equal to about 70 wt.%, and in certain aspects, optionally greater than or equal to about 10 wt.% to less than or equal to about 50 wt.%, of the lithium salt, and greater than or equal to about 30 wt.% to less than or equal to about 95 wt.%, and in certain aspects, optionally greater than or equal to about 50 wt.% to less than or equal to about 90 wt.%, of the solvent. The liquid electrolyte may include greater than or equal to 5 wt.% to less than or equal to 70 wt.%, and in certain aspects, optionally greater than or equal to 10 wt.% to less than or equal to 50 wt.%, of the lithium salt, and greater than or equal to 30 wt.% to less than or equal to 95 wt.%, and in certain aspects, optionally greater than or equal to 50 wt.% to less than or equal to 90 wt.%, of the solvent.

The lithium salt includes a lithium cation (Li⁺) and at least one anion selected from the group consisting of: hexafluoroarsenate, hexafluorophosphate, bis(fluorosulfonyl)imide (FSI), perchlorate, tetrafluoroborate, cyclo-difluoromethane-1,1-bis(sulfonyl)imide (DMSI), bis(trifluoromethanesulfonyl)imide (TFSI), bis(pentafluoroethanesulfonyl)imide (BETI), bis(oxalate)borate (BOB), difluoro(oxalato)borate (DFOB), bis(fluoromalonato)boarate (BFMB), and combinations thereof. For example, in certain variations, the lithium salt may be selected from the group consisting of: lithium hexafluoroarsenate (LiAsF₆), lithium hexafluorophosphate (LiPF₆), lithium bis(fluorosulfonyl)imide (LiFSI), lithium bis(trifluoromethanesulfonyl)imide (LiTFSI), lithium perchlorate (LiClO₄), lithium tetrafluoroborate (LiBF₄), lithium-cyclo-difluoromethane-1,1-bis(sulfonyl)imide (LiDMSI), lithium bis(trifluoromethanesulfonyl)imide (LiTFSI), lithium bis(pentafluoroethanesulfonyl)imide (LiBETI), lithium bis(oxalato)borate (LiBOB), lithium difluoro(oxalato)borate (LiDFOB), lithium bis(monofluoromalonato)borate (LiBFMB), lithium difluorophosphate (LiPO₂F₂), lithium fluoride (LiF), lithium trifluoromethyl sulfonate (LiTFO), lithium difluoro(oxalato)borate (LiDFOB), and combinations thereof.

The solvent dissolves the lithium salt to enable good lithium ion conductivity, while also exhibiting a low vapor pressure (e.g., less than about 10 mmHg at 25° C.) to match the cell fabrication process. In various aspects, the solvent includes, for example, carbonate solvents (such as, ethylene carbonate (EC), propylene carbonate (PC), glycerol carbonate, vinylene carbonate, fluoroethylene carbonate, 1,2-butylene carbonate, and the like), lactones (such as, γ-butyrolactone (GBL), δ-valerolactone, and the like), nitriles (such as, succinonitrile, glutaronitrile, adiponitrile, and the like), sulfones (such as, tetramethylene sulfone, ethyl methyl sulfone, vinyl sulfone, phenyl sulfone, 4-fluorophenyl sulfone, benzyl sulfone, and the like), ethers (such as, triethylene glycol dimethylether (triglyme, G3), tetraethylene glycol dimethylether (tetraglyme, G4), 1,3-dimethyoxy propane, 1,4-dioxane, and the like), phosphates (such as, triethyl phosphate, trimethyl phosphate, and the like), ionic liquids including ionic liquid cations (such as, 1-ethyl-3-methylimidazolium ([Emim]⁺), 1-propyl-1-methylpiperidinium ([PP_{13]}⁺), 1-butyl-1-methylpiperidinium ([PP₁₄]⁺), 1-methyl-1-ethylpyrrolidinium ([Pyr₁₂]⁺), 1-propyl-1-methylpyrrolidinium ([Pyr₁₃]⁺), 1-butyl-1-methylpyrrolidinium ([Pyr₁₄]⁺), and the like) and ionic liquid anions (such as, bis(trifluoromethanesulfonyl)imide (TFSI), bis(fluorosulfonyl imide (FS), and the like), and combinations thereof.

In various aspects, as illustrated in FIG. 1C, the battery 20 may further include a solid-state interlayer 102. For example, as illustrated, the battery 20 may include a solid-state interlayer 102 disposed between the electrolyte layer 26 and the positive electrode 24. The solid-state interlayer 102 may physically separate the electrolyte layer 26 and the positive electrode 24. The solid-state interlayer 102 may cover greater than or equal to about 50 % to less than or equal to about 100 %, and in certain aspects, optionally greater than or equal to 50 % to less than or equal to 100 %, of a total surface area of the positive electrode 24 that opposes the electrolyte layer 26. In each instance, the solid-state layer 102 may be a high electrochemical stable solid-state interlayer having a parasitic current during linear sweeping voltammetry of less than about 1 micro ampere, and in certain aspects, optionally, less than 1 micro ampere.

The solid-state interlayer 102 may have a particle-width thickness. For example, the solid-state interlayer 102 may comprise a (fourth) plurality of solid-state electrolyte particles 104. The solid-state electrolyte particles 104 may have an average diameter greater than or equal to about 0.005 µm to less than or equal to about 5 µm, and the solid-state interlayer 102 may have an average thickness greater than or equal to about 0.1 µm to less than or equal to about 8 µm, optionally greater than or equal to about 0.1 µm to less than or equal to about 5 µm, and in certain instances, optionally about 4 µm.The solid-state electrolyte particles 104 may have an average diameter greater than or equal to 0.005 µm to less than or equal to 5 µm, and the solid-state interlayer 102 may have an average thickness greater than or equal to 0.1 µm to less than or equal to 8 µm, optionally greater than or equal to 0.1 µm to less than or equal to 5 µm, and in certain instances, optionally 4 µm.As illustrated, the polymeric gel electrolyte 100 may fill voids between the solid-state electrolyte particles 104 and/or between the solid-state electrolyte particles 104 and/or the solid-state electrolyte particles 92 and/or the positive solid-state electroactive particles 60 and/or the solid-state electrolyte particles 30.

In certain variations, the solid-state electrolyte particles 104 may comprise Li₁₊ₓAlₓTi₂₋ₓ(PO₄)₃, where 0 ≤ x ≤ 2 (LATP). In other variations, the solid-state particles 104 may comprise other oxide-based solid-state electrolytes, such as garnet ceramics, LISICON-type oxides, Perovskite-type ceramics, and/or NASICON-type oxides. In still other variations, the solid-state particles 104 may include nitride-based particles, halide-based particles, and borate-based particles.

In various aspects, the garnet ceramics may be selected from the group consisting of: Li₇La₃Zr₂O₁₂, Li_{6.2}Ga_{0.3}La_{2.95}Rb_{0.05}Zr₂O₁₂, Li_{6.85}La_{2.9}Ca_{0.1}Zr₁.₇₅Nb_{0.25}O₁₂, and combinations thereof. The LISICON-type oxides may be selected from the group consisting of: Li₂₊₂ₓZn₁₋ₓGeO₄ (where 0 < x < 1), Li₁₄Zn(GeO₄)₄, and combinations thereof. The Perovskite-type ceramics may be selected from the group consisting of: Li_{3.3}La_{0.53}TiO₃, LiSr_{1.65}Zr_{1.3}Ta_{1.}7O₉, Li_{2x-y}Sr₁₋ₓTa_{y}Zr_{1-y}O₃ (where x = 0.75y and 0.60 < y < 0.75), and combinations thereof. The NASICON-type oxides may be selected from the group consisting of: Li₁₊ₓAlₓGe₂₋_{X}(PO₄)₃ (where 0 ≤ x ≤ 2) (LAGP), Li_{1.4}Al_{0.4}Ti_{1.6}(PO₄)₃, Li_{1.3}Al_{0.3}Ti_{1.7}(PO₄)₃, LiTi₂(PO₄)₃, and combinations thereof. The nitride-based particles may include, for example only, Li₃N, Li₇PN₄, LiSi₂N₃, and combinations thereof. The halide-based particles may include, for example only, LiI, Li₃InCl₆, Li₂CdC1₄, Li₂MgCl₄, LiCdI₄, Li₂ZnI₄, Li₃OCl, Li₃YCl₆, Li₃YBr₆, and combinations thereof. The borate-based particles may include, for example only, Li₂B₄O₇, Li₂O—B₂O₃—P₂O₅, and combinations thereof.

In various aspects, the solid-state electrolyte particles 104 may comprise a solid-state electrolyte material selected from the group consisting of: Li₁₊ₓAlₓTi₂₋ₓ(PO₄)₃, where 0 ≤ x < 2 (LATP Li₂₊₂ₓZn₁₋ₓGeO₄ (where 0 < x < 1), Li₁₄Zn(GeO₄)₄,), Li₇La₃Zr₂O₁₂, Li_{6.2}Ga_{0.3}La_{2.95}Rb_{0.05}Zr₂O₁₂, Li_{6.85}La_{2.9}Ca_{0.1}Zr_{1.75}Nb_{0.25}O₁₂, Li₂₊₂ₓZn₁₋ₓGeO₄ (where 0 < x < 1), Li₁₄Zn(GeO₄)₄, Li_{3.3}La_{0.53}TiO₃, LiSr_{1.65}Zr_{1.3}Ta_{1.7}O₉, Li_{2x-y}Sr₁₋ₓTa_{y}Zr_{1-y}O₃ (where x = 0.75y and 0.60 < y < 0.75), Li₁₊ₓAlₓGe₂₋ₓ(PO₄)₃ (where 0 ≤ x ≤ 2) (LAGP), Li_{1.4}Al_{0.4}Ti_{1.6}(PO₄)₃, Li_{1.3}Al_{0.3}Ti_{1.7}(PO₄)₃, LiTi₂(PO₄)₃, Li₃N, Li₇PN₄, LiSi₂N₃, LiI, Li₃InC1₆, Li₂CdC1₄, Li₂MgCl₄, LiCdI₄, Li₂ZnI₄, Li₃OCl, Li₃YC1₆, Li₃YBr₆, Li₂B₄O₇, Li₂O—B₂O₃—P₂O₅, and combinations thereof.

Although not illustrated, the skilled artisan will recognize that in certain variations, another solid-state interlayer may be disposed between the negative electrode 22 and the electrolyte layer 26. Further still, in certain variations, a solid-state interlayer may be disposed between the negative electrode 22 and the electrolyte layer 26 in place of the solid-state interlayer 102 disposed between the positive electrode 24 and the electrolyte interlayer 26, as illustrated.

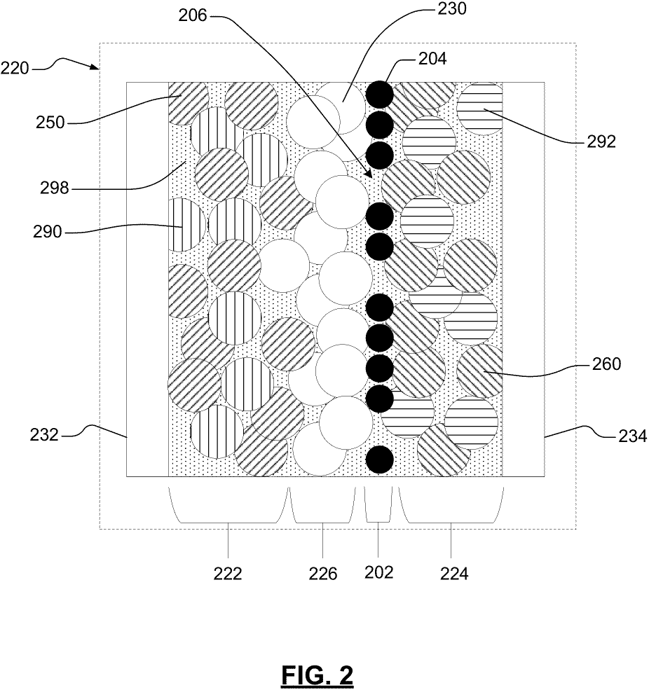

An exemplary and schematic illustration of another solid-state electrochemical unit 220 that cycles lithium ions is shown in FIG. 2. Like battery 20 illustrated in FIGS. 1A-1C, the battery 220 includes a negative electrode (i.e., anode) 222, a first current collector 232 positioned at or near a first side of the negative electrode 222, a positive electrode (i.e., cathode) 224, a second current collector 234 positioned at or near a first side of the positive electrode 224, and an electrolyte layer 226 disposed between a second side of the negative electrode 222 and a second side of the positive electrode 224, where the second side of the negative electrode 222 is substantially parallel with the first side of the negative electrode 222, and the second side of the positive electrode 224 is substantially parallel with the first side of the positive electrode 224.

The battery 220 further includes a solid-state interlayer 202 disposed between the electrolyte layer 226 and the second side of the positive electrode 224. Like the solid-state interlayer 102 illustrated in FIG. 1C, the solid-state interlayer 202 may physically separate the electrolyte layer 226 and the positive electrode 224. The solid-state interlayer 202, however, may further include a plurality of through-holes 206. For example, the solid-state interlayer 202 may cover greater than or equal to about 50% to less than or equal to about 100%, and in certain aspects, optionally greater than or equal to 50% to less than or equal to 100%, of a total surface area of the second side of the positive electrode 224. The through-holes 206 may have an average diameter greater than or equal to about 0.05 µm to less than or equal to about 100 µm, and in certain aspects, optionally greater than or equal to about 5 µm to less than or equal to about 50 µm.The through-holes 206 may have an average diameter greater than or equal to 0.05 µm to less than or equal to 100 µm, and in certain aspects, optionally greater than or equal to 5 µm to less than or equal to 50 µm.In each instance, the through-holes 206 may provide a pathway for rapid and fast lithium ion transportation, especially at lower operation temperatures.

Like the solid-state interlayer 102 illustrated in FIG. 1C, the solid-state interlayer 202 may have a particle-width thickness. For example, the solid-state interlayer 202 may comprise a (first) plurality of solid-state electrolyte particles 204. The solid-state electrolyte particles 204 may have an average diameter greater than or equal to about 0.005 µm to less than or equal to about 5 µm, and the solid-state interlayer 202 may have an average thickness greater than or equal to about 0.1 µm to less than or equal to about 8 µm, optionally greater than or equal to about 0.1 µm to less than or equal to about 5 µm, and in certain instances, optionally about 4 µm. The solid-state electrolyte particles 204 may have an average diameter greater than or equal to 0.005 µm to less than or equal to 5 µm, and the solid-state interlayer 202 may have an average thickness greater than or equal to 0.1 µm to less than or equal to 8 µm, optionally greater than or equal to 0.1 µm to less than or equal to 5 µm, and in certain instances, optionally 4 µm.

Further still, like the solid-state electrolyte particles 104 illustrated in FIG. 1C, the solid-state electrolyte particles 204 may comprise Li₁+ₓAlₓTi₂₋ₓ(PO₄)₃, where 0 ≤ x ≤ 2 (LATP). In other variations, the solid-state particles 204 may comprise other oxide-based solid-state electrolytes, such as garnet ceramics, LISICON-type oxides, Perovskite-type ceramics, and/or NASICON-type oxides. In still other variations, the solid-state particles 204 may include nitride-based particles, halide-based particles, and borate-based particles. Although not illustrated, the skilled artisan will recognize that in certain variations, another solid-state interlayer may be disposed between the second side of the negative electrode 222 and the electrolyte layer 226.

Like the negative electrode 22 illustrated in FIGS. 1A-1C, the negative electrode 222 may be in a form of a layer that is defined by a plurality of negative solid-state electroactive particles 250 optionally mixed a (second) plurality of solid-state electrolyte particles 290. Like the positive electrode 24 illustrated in FIGS. 1A-1C, the positive electrode 224 may be in the form of a layer that is defined by plurality of positive solid-state electroactive particles 260 optionally mixed with a (third) plurality of solid-state electrolyte particles 292. Like the electrolyte layer 26 illustrated in FIGS. 1A-1C, the electrolyte layer 226 may be in the form of a layer that is defined by a (fourth) plurality of solid-state electrolyte particles 230. In certain variations, as illustrated, the battery 220 may further include a polymeric gel system 298. Like the polymeric gel system 100 illustrated in FIG. 1C, the polymeric gel system 298 may at least partially fill void spaces between the solid-state particles, including the solid-state electrolyte particles 204 and /or the negative solid-state electroactive particles 250 and/or the solid-state electrolyte particles 290 and/or the positive solid-state electroactive particles 260 and/or solid-state electrolyte particles 292 and/or the solid-state electrolyte particles 230.

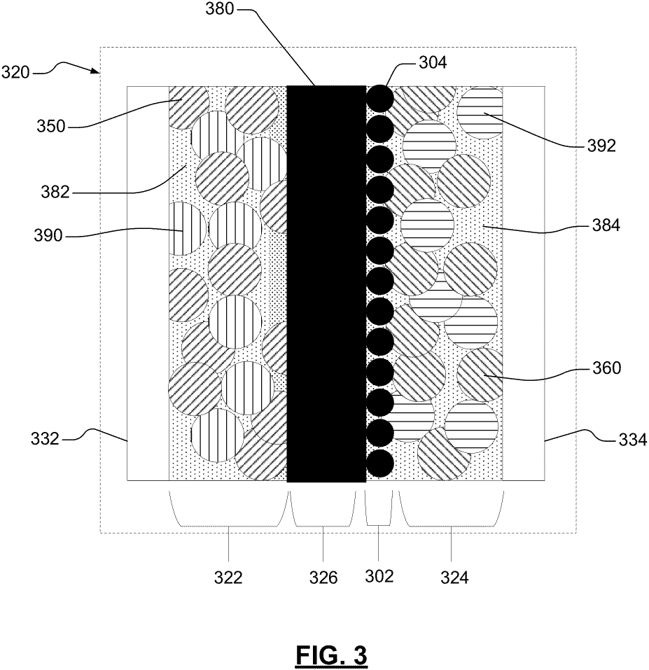

An exemplary and schematic illustration of another solid-state electrochemical unit 320 that cycles lithium ions is shown in FIG. 3. Like battery 20 illustrated in FIGS. 1A-1C, the battery 320 includes a negative electrode (i.e., anode) 322, a first current collector 332 positioned at or near a first side of the negative electrode 322, a positive electrode (i.e., cathode) 324, a second current collector 334 positioned at or near a first side of the positive electrode 324, an electrolyte layer 326 disposed between a second side of the negative electrode 322 and a second side of the positive electrode 324, and a solid-state interlayer 302 disposed between the second side of the positive electrode 324 and the electrolyte layer 326, where the second side of the negative electrode 322 is substantially parallel with the first side of the negative electrode 322, and the second side of the positive electrode 324 is substantially parallel with the first side of the positive electrode 324.

Like the negative electrode 22 illustrated in FIGS. 1A-1C, the negative electrode 322 may be in the form of a layer defined by a plurality of negative solid-state electroactive particles 350 optionally mixed with a (first) plurality of solid-state electrolyte particles 390. The negative electrode 322 may further include a (first) polymeric gel electrolyte system 382 that at least partially fills void spaces between the negative solid-state electroactive particles 350 and/or the optional solid-state electrolyte particles 390.

Like the positive electrode 24 illustrated in FIGS. 1A-1C, the positive electrode 324 may be in the form of a layer defined by plurality of positive solid-state electroactive particles 360 optionally mixed with a (second) plurality of solid-state electrolyte particles 392. The positive electrode 324 may further include a (second) polymeric gel system 384 that at least partially fills void spaces between the positive solid-state electroactive particles 360 and/or the optional solid-state electrolyte particles 392. The (second) polymeric gel system 384 may be the same or different from the (first) polymeric gel system 382.

Like the electrolyte layer 26 illustrated in FIGS. 1A-1C, the electrolyte layer 326 may be a separating layer that physically separates the negative electrode 322 from the positive electrode 324. In various aspects, the electrolyte layer 326 may be a free-standing membrane 380 defined by a (third) polymeric gel electrolyte system. In certain variations, the free-standing membrane 380 may have a thickness greater than or equal to about 5 µm to less than or equal to about 1,000 µm, optionally greater than or equal to about 2 µm to less than or equal to about 200 µm, optionally greater than or equal to about 5 µm to less than or equal to about 200 µm, and in certain aspects, optionally greater than or equal to about 2 µm to less than or equal to about 50 µm.The free-standing membrane 380 may have a thickness greater than or equal to 5 µm to less than or equal to 1,000 µm, optionally greater than or equal to 2 µm to less than or equal to 200 µm, optionally greater than or equal to 5 µm to less than or equal to 200 µm, and in certain aspects, optionally greater than or equal to 2 µm to less than or equal to 50 µm.

Like the solid-state interlayer 102 illustrated in FIG. 1C, the solid-state interlayer 302 may physically separate the electrolyte layer 326 and the positive electrode 324. The solid-state interlayer 302 may have a particle-width thickness. For example, the solid-state interlayer 302 may comprise a (third) plurality of solid-state electrolyte particles 304. The solid-state electrolyte particles 304 may have an average diameter greater than or equal to about 0.005 µm to less than or equal to about 5 µm, and the solid-state interlayer 302 may have an average thickness greater than or equal to about 0.1 µm to less than or equal to about 8 µm, optionally greater than or equal to about 0.1 µm to less than or equal to about 5 µm, and in certain instances, optionally about 4 µm.The solid-state electrolyte particles 304 may have an average diameter greater than or equal to 0.005 µm to less than or equal to 5 µm, and the solid-state interlayer 302 may have an average thickness greater than or equal to 0.1 µm to less than or equal to 8 µm, optionally greater than or equal to 0.1 µm to less than or equal to 5 µm, and in certain instances, optionally 4 µm.

Further still, like the solid-state electrolyte particles 104 illustrated in FIG. 1C, the solid-state electrolyte particles 304 may comprise Li₁+ₓAlₓTi₂₋ₓ(PO₄)₃, where 0 ≤ x ≤ 2 (LATP). In other variations, the solid-state particles 204 may comprise other oxide-based solid-state electrolytes, such as garnet ceramics, LISICON-type oxides, Perovskite-type ceramics, and/or NASICON-type oxides. In still other variations, the solid-state particles 304 may include nitride-based particles, halide-based particles, and borate-based particles.

Although not illustrated, the skilled artisan will recognize that in certain variations the solid-state interlayer 302 may further include a plurality of through-holes, like the solid-state interlayer 202 illustrated in FIG. 2. In each variation, the (second) polymeric gel system 384 may at least partially fills void spaces between the solid-state electrolyte particles 304 and/or the positive solid-state electroactive particles 360 and/or the optional solid-state electrolyte particles 392. Moreover, although not illustrated, the skilled artisan will recognize that in certain variations, another solid-state interlayer may be disposed between the second side of the negative electrode 322 and the electrolyte layer 326.

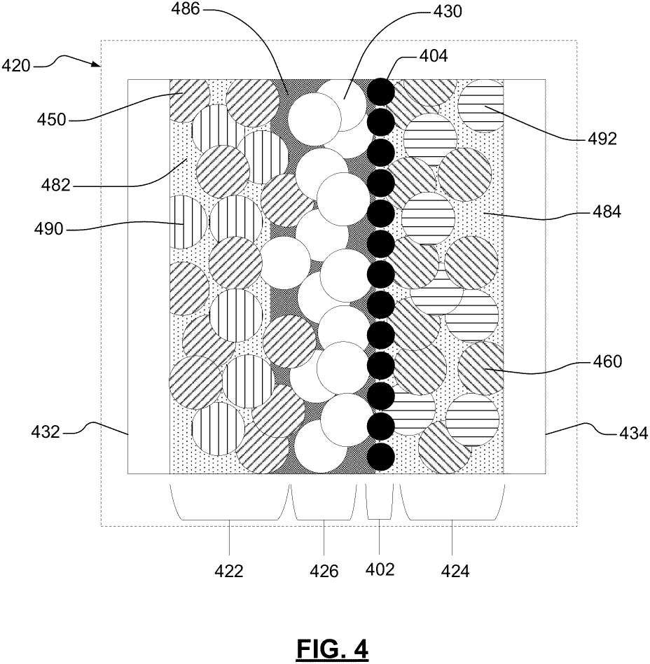

An exemplary and schematic illustration of another solid-state electrochemical unit 420 that cycles lithium ions is shown in FIG. 4. Like battery 20 illustrated in FIGS. 1A-1C, the battery 420 includes a negative electrode (i.e., anode) 422, a first current collector 432 positioned at or near a first side of the negative electrode 422, a positive electrode (i.e., cathode) 424, a second current collector 434 positioned at or near a first side of the positive electrode 424, an electrolyte layer 426 disposed between a second side of the negative electrode 422 and a second side of the positive electrode 424, and a solid-state interlayer 402 disposed between the second side of the positive electrode 424 and the electrolyte layer 426, where the second side of the negative electrode 422 is substantially parallel with the first side of the negative electrode 422, and the second side of the positive electrode 424 is substantially parallel with the first side of the positive electrode 424.

Like the negative electrode 22 illustrated in FIGS. 1A-1C, the negative electrode 422 may be in the form of a layer defined by a plurality of negative solid-state electroactive particles 450 optionally mixed with a (first) plurality of solid-state electrolyte particles 490. The negative electrode 422 may further include a (first) polymeric gel electrolyte system 482 that at least partially fills void spaces between the negative solid-state electroactive particles 450 and/or the optional solid-state electrolyte particles 490.

Like the positive electrode 24 illustrated in FIGS. 1A-1C, the positive electrode 424 may be in the form of a layer defined by plurality of positive solid-state electroactive particles 460 optionally mixed with a (second) plurality of solid-state electrolyte particles 492. The positive electrode 424 may further include a (second) polymeric gel system 484 that at least partially fills void spaces between the positive solid-state electroactive particles 460 and/or the optional solid-state electrolyte particles 492. The (second) polymeric gel system 484 may be the same or different from the (first) polymeric gel system 482.

Like the electrolyte layer 26 illustrated in FIGS. 1A-1C, the electrolyte layer 426 may be in the form of a layer that is defined by a (third) plurality of solid-state electrolyte particles 430. The electrolyte layer 26 may further include a (third) polymeric gel system 486 that at least partially fills void spaces between the solid-state electrolyte particles 430. The (third) polymeric gel system 486 may be the same or different from the (first) polymeric gel system 482 and/or the (second) polymeric gel system 484.

Like the solid-state interlayer 102 illustrated in FIG. 1C, the solid-state interlayer 402 may physically separate the electrolyte layer 426 and the positive electrode 424. The solid-state interlayer 402 may have a particle-width thickness. For example, the solid-state interlayer 402 may comprise a (fourth) plurality of solid-state electrolyte particles 404. The solid-state electrolyte particles 404 may have an average diameter greater than or equal to about 0.005 µm to less than or equal to about 5 µm, and the solid-state interlayer 402 may have an average thickness greater than or equal to about 0.1 µm to less than or equal to about 8 µm, optionally greater than or equal to about 0.1 µm to less than or equal to about 5 µm, and in certain instances, optionally about 4 µm.The solid-state electrolyte particles 404 may have an average diameter greater than or equal to 0.005 µm to less than or equal to 5 µm, and the solid-state interlayer 402 may have an average thickness greater than or equal to 0.1 µm to less than or equal to 8 µm, optionally greater than or equal to 0.1 µm to less than or equal to 5 µm, and in certain instances, optionally 4 µm.

Further still, like the solid-state electrolyte particles 104 illustrated in FIG. 1C, the solid-state electrolyte particles 404 may comprise Li₁,ₓAlₓTi₂₋ₓ(PO₄)₃, where 0 ≤ x ≤ 2 (LATP). In other variations, the solid-state particles 204 may comprise other oxide-based solid-state electrolytes, such as garnet ceramics, LISICON-type oxides, Perovskite-type ceramics, and/or NASICON-type oxides. In still other variations, the solid-state particles 404 may include nitride-based particles, halide-based particles, and borate-based particles.

Although not illustrated, the skilled artisan will recognize that in certain variations the solid-state interlayer 402 may further include a plurality of through-holes, like the solid-state interlayer 202 illustrated in FIG. 2. In each variation, the (second) polymeric gel system 484 may at least partially fills void spaces between the solid-state electrolyte particles 404 and/or the positive solid-state electroactive particles 460 and/or the optional solid-state electrolyte particles 492. Moreover, although not illustrated, the skilled artisan will recognize that in certain variations, another solid-state interlayer may be disposed between the second side of the negative electrode 422 and the electrolyte layer 426.

In various aspects, the present disclosure provides methods for fabricating a battery, like the battery 20 illustrated in FIG. 1C. The method may include preparing a first or positive electrode, which includes a plurality of first or positive solid-state electroactive particles and optionally a (first) plurality of solid-state electrolyte particles. In certain variations, preparing the positive electrode may include contacting positive solid-state electroactive particles and optionally the solid-state electrolyte particles to form a (first) slurry and disposing the slurry on or adjacent to one or more surfaces of a (first) current collector. In such instances, the method may further include drying the slurry to form the positive electrode.

The method further includes forming a solid-state interlayer on or adjacent to an exposed surface of the positive electrode. Forming the solid-state interlayer may include disposing a particle layer on the exposed surface of the positive electrode. The particle layer may include a (second) plurality of solid-state electrolyte particles. Further still, the method may include contacting a (first) polymeric gel electrolyte precursor liquid with the positive electrode and the solid-state interlayer. In such instances, the method may include drying or reacting (e.g., cross-linking) the (first) precursor liquid to form a gel-assisted first or positive electrode that includes a first polymeric gel electrolyte and the solid-state interlayer.

For example, the positive electrode may be heated to a temperature greater than or equal to about 10° C. to less than or equal to about 200° C., and in certain aspects, optionally about 25° C., for a period greater than or equal to about 0.1 hours to less than or equal to about 48 hours, and in certain aspects, optionally about 1 hour, to form the gel-assisted positive electrode, including the solid-state interlayer. The positive electrode may be heated to a temperature greater than or equal to 10° C. to less than or equal to 200° C., and in certain aspects, optionally 25° C., for a period greater than or equal to 0.1 hours to less than or equal to 48 hours, and in certain aspects, optionally 1 hour, to form the gel-assisted positive electrode, including the solid-state interlayer.

In certain variations, the method may further include aligning the gel-assisted positive electrode having a solid-state interlayer with an electrolyte layer and/or a second or negative electrode. The electrolyte layer may be free-standing electrolyte layer. In some variations, the electrolyte layer may include a (third) plurality of solid-state electrolyte particles. The electrolyte layer may be prepared by contacting a (second) polymeric gel electrolyte precursor liquid with a precursor electrolyte layer and drying or reacting (e.g., cross-linking) the (second) precursor liquid. For example, the precursor electrolyte layer including the (second) precursor liquid may be heated to a temperature greater than or equal to about 10° C. to less than or equal to about 200° C., and in certain aspects, optionally about 25° C., for a period greater than or equal to about 0.1 hours to less than or equal to about 48 hours, and in certain aspects, optionally about 1 hour, to form the electrolyte layer. The precursor electrolyte layer including the (second) precursor liquid may be heated to a temperature greater than or equal to 10° C. to less than or equal to 200° C., and in certain aspects, optionally 25° C., for a period greater than or equal to 0.1 hours to less than or equal to 48 hours, and in certain aspects, optionally 1 hour, to form the electrolyte layer.

The negative electrode includes a plurality of second or negative solid-state electroactive particles and optionally a (fourth) plurality of solid-state electrolyte particles. The negative electrode may be prepared by contacting a (third) polymeric gel electrolyte precursor liquid with an anode precursor and drying or reacting (e.g., cross-linking) the (third) precursor liquid to form the gel-assisted negative electrode. For example, the precursor negative electrode including the (third) precursor liquid may be heated to a temperature greater than or equal to about 10° C. to less than or equal to about 200° C., and in certain aspects, optionally about 25° C., for a period greater than or equal to about 0.1 hours to less than or equal to about 48 hours, and in certain aspects, optionally about 1 hour to form the gel-assisted negative electrode. The precursor negative electrode including the (third) precursor liquid may be heated to a temperature greater than or equal to 10° C. to less than or equal to 200° C., and in certain aspects, optionally 25° C., for a period greater than or equal to 0.1 hours to less than or equal to 48 hours, and in certain aspects, optionally 1 hour to form the gel-assisted negative electrode.

The third precursor liquid may be the same as or different form the second precursor liquid, and the second precursor liquid may be the same as or different from the first precursor liquid. Similarly, the first plurality of solid-state electrolyte particles may be the same as or different from the third plurality of solid-state electrolyte particles, and the third plurality of solid-state electrolyte particles may be the same as or different from the fourth plurality of solid-state electrolyte particles.

In various aspects, the present disclosure provides other methods for fabricating a battery, like the battery 20 illustrated in FIG. 1C. The method may include preparing a first or positive electrode including a solid-state interlayer. The methods may further include aligning the positive electrode with an electrolyte layer and/or a second or negative electrode to form a cell. In such instances, a polymeric gel precursor may be added to the assembled cell and subsequently dried or reacted (e.g., cross-linking) to form the gel-assisted electrolyte system. In certain variations, the method may further include preparing the electrolyte layer and/or the negative electrode.

Certain features of the current technology are further illustrated in the following non-limiting examples.

### Example 1

Example battery cells may be prepared in accordance with various aspects of the present disclosure. For example, an example battery cell 510 may be prepared that includes a solid-state interlayer—for example, like the solid-state interlayer 102 as illustrated in FIG. 1C, the solid-state interlayer 202 as illustrated in FIG. 2, the solid-state interlayer 302 as illustrated in FIG. 3, and/or the solid-state interlayer 402 as illustrated in FIG. 4. A comparative battery cell 520 may have similar battery configuration as the example battery cell 510, but omits the solid-state interlayer.

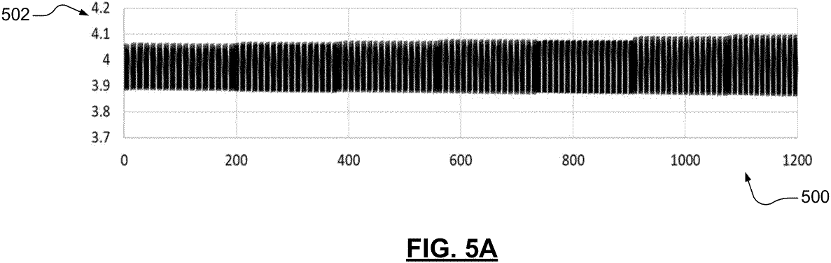

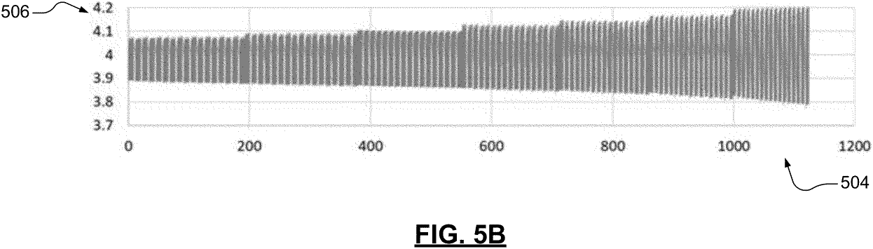

FIG. 5A is a graphical illustration representing the thermal stability of the example battery cell 510, where the x-axis 500 represents time (hours), and the y-axis 502 represents voltage (V) during charge and discharge between about 30% state of charge (“SOC”) and about 60% state of charge (“SOC”) at high operation temperatures. FIG. 5B is a graphical illustration representing the thermal stability of the comparative battery cell 520, where the x-axis 504 represents time (hours), and the y-axis 506 represents voltage (V) during charge and discharge between about 30% state of charge (“SOC”) and about 60 % state of charge (“SOC”) at high operation temperatures. As illustrated, the example battery cell 510 prepared in accordance with various aspects of the present disclosure has improved long-term thermal stability.

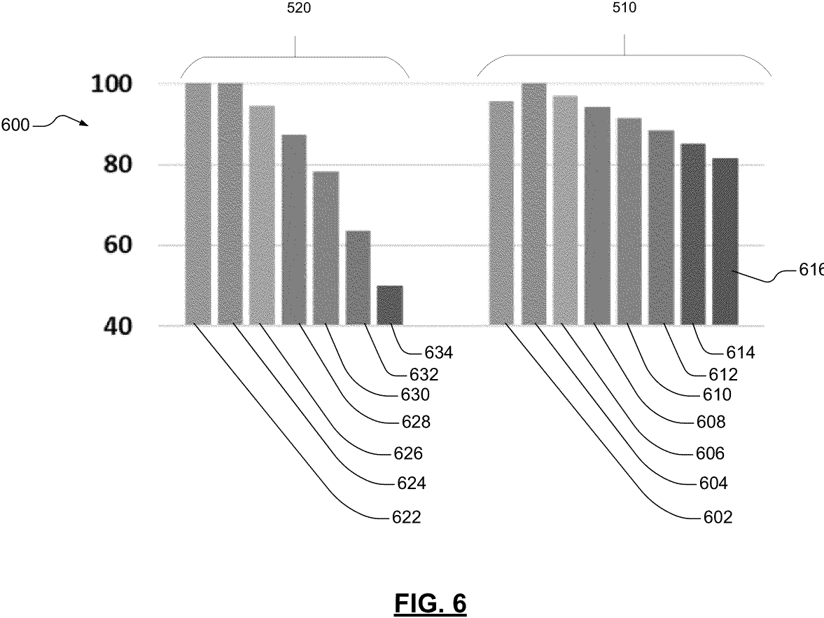

FIG. 6 is a graphical illustration representing the capacity retention of the example battery cell 510 and the comparative battery cell 520, where y-axis 600 represents capacity retention (%). As illustrated, 602 represents an uncycled example battery cell 510, 604 represents the example battery cell 510 after 510 cycles, 606 represents the example battery cell 510 after 1020 cycles, 608 represents the example battery cell 510 after 1530 cycles, 610 represents the example battery cell 510 after 2040 cycles, 612 represents the example battery cell 510 after 2550 cycles, 614 represents the example battery cell 510 after 3060 cycles, 616 represents the example battery cell 510 after 3570 cycles. As illustrated, 622 represents an uncycled the comparative battery cell 520, 624 represents the comparative battery cell 520 after 510 cycles, 626 represents the comparative battery cell 520 after 1020 cycles, 628 represents the comparative battery cell 520 after 1530 cycles, 630 represents the comparative battery cell 520 after 2040 cycles, 632 represents the comparative battery cell 520 after 2550 cycles, and 634 represents the comparative battery cell 520 after 3060 cycles. As illustrated, the example battery cell 510 prepared in accordance with various aspects of the present disclosure has improved capacity retention during high temperature cycling.

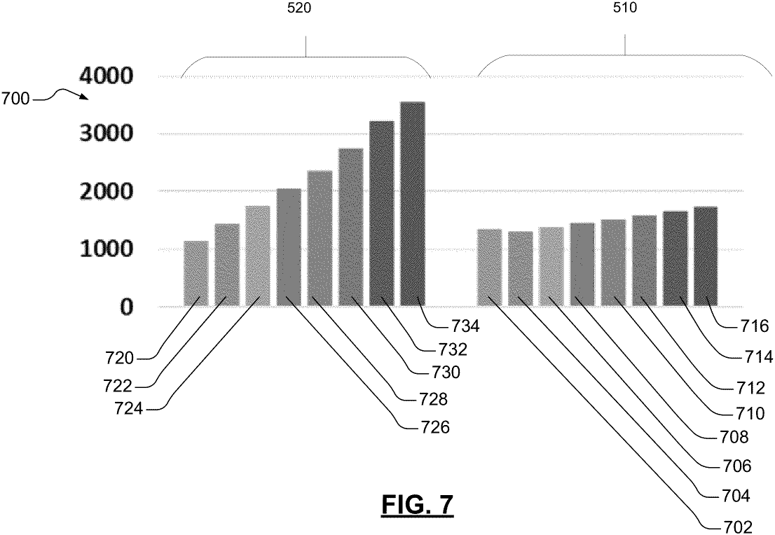

FIG. 7 is a graphical illustration representing the direct current resistance (“DCR”) of the example battery cell 510 and the comparative battery cell 520, where the y-axis 700 represents direct current resistance (“DCR”) in mOhms. As illustrated, 702 represents an uncycled example battery cell 510, 704 represents the example battery cell 510 after 510 cycles, 706 represents the example battery cell 510 after 1020 cycles, 708 represents the example battery cell 510 after 1530 cycles, 710 represents the example battery cell 510 after 2040 cycles, 712 represents the example battery cell 510 after 2550 cycles, 714 represents the example battery cell 510 after 3060 cycles, and 716 represents the example battery cell 510 after 3570 cycles. As illustrated, 722 represents an uncycled the comparative battery cell 520, 724 represents the comparative battery cell 520 after 510 cycles, 726 represents the comparative battery cell 520 after 1020 cycles, 728 represents the comparative battery cell 520 after 1530 cycles, 730 represents the comparative battery cell 520 after 2040 cycles, 732 represents the comparative battery cell 520 after 2550 cycles, 734 represents the comparative battery cell 520 after 3060 cycles, and 736 represents the comparative battery cell 520 after 3570 cycles. As illustrated, the example battery cell 510 prepared in accordance with various aspects of the present disclosure has lower cell resistance and lower resistance increasement rate during high temperature cycling.

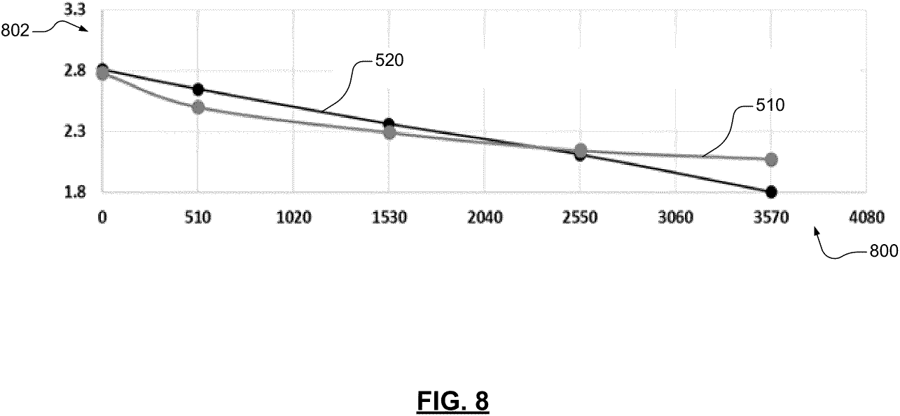

FIG. 8 is a graphical illustration representing the starting, lighting, ignition (“SLI”) cranking after high temperature cycling of the example battery cell 510 and the comparative battery cell 520, where the x-axis 800 represents cycle times and the y-axis 802 represents voltage (V). As illustrated, the example battery cell 510 prepared in accordance with various aspects of the present disclosure has improved cold-cranking capability after high temperature cycling.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electrochemical cell that cycles lithium ions, wherein the electrochemical cell comprises:
an electrode comprising a plurality of solid-state electroactive particles;
a solid-state electrolyte layer; and
a solid-state interlayer disposed between the electrode and the solid-state electrolyte layer, the solid-state interlayer comprising a plurality of first solid-state electrolyte particles, and the solid-state interlayer having a thickness greater than or equal to about 0.1 micrometers (µm) to less than or equal to about 8 µm.

2. The electrochemical cell of claim 1, wherein the first solid-state electrolyte particles are selected from the group consisting of: Li₁₊ₓAlₓTi₂₋ₓ(PO₄)₃, where 0 ≤ × ≤ 2 (LATP Li₂₊₂ₓZn₁₋ₓGeO₄ (where 0 < x < 1), Li₁₄Zn(GeO₄)₄,), Li₇La₃Zr₂O₁₂, Li_{6.2}Ga_{0.3}La_{2.95}Rb_{0.05}Zr₂O₁₂, Li_{6.85}La_{2.9}Ca_{0.1}Zr_{1.75}Nb_{0.25}O₁₂, Li₂₊₂ₓZn₁₋ₓGeO₄ (where 0 < x < 1), Li₁₄Zn(GeO₄)₄, Li_{3.3}La_{0.53}TiO₃, LiSr_{1.65}Zr_{1.3}Ta_{1.7}O₉, Li_{2x-y}Sr₁₋ₓTa_{y}Zr_{1-y}O₃ (where x = 0.75y and 0.60 < y < 0.75), Li₁₊ₓAlₓGe₂₋ₓ(PO₄)₃ (where 0 ≤ × ≤ 2) (LAGP), Li_{1.4}Al_{0.4}Ti_{1.6}(PO₄)₃, Li_{1.3}Al_{0.3}Ti_{1.7}(PO₄)₃, LiTi₂(PO₄)₃, Li₃N, Li₇PN₄, LiSi₂N₃, LiI, Li₃InCl₆, Li₂CdCl₄, Li₂MgCl₄, LiCdI₄, Li₂ZnI₄, Li₃OCl, Li₃YCl₆, Li₃YBr₆, Li₂B₄O₇, Li₂O—B₂O₃—P₂O₅, and combinations thereof.

3. The electrochemical cell of claim 2, wherein the electrode comprises a plurality of second solid-state electrolyte particles.

4. The electrochemical cell of claim 3, wherein the second solid-state electrolyte particles are the same as the first electrolyte particles.

5. The electrochemical cell of claim 2, wherein the solid-state electrolyte layer comprises a plurality of second electrolyte particles, wherein the second electrolyte particles are different from the first electrolyte particles.

6. The electrochemical cell of claim 5, wherein the solid-state electrolyte layer further comprises a polymeric gel electrolyte that at least partially fills voids between the second electrolyte particles.

7. The electrochemical cell of claim 1, wherein the solid-state electrolyte layer is a free-standing membrane defined by a polymeric gel, wherein the free-standing membrane has a thickness greater than or equal to about 5 micrometers (µm) to less than or equal to about 200 µm.

8. The electrochemical cell of claim 1, further comprising:
a polymeric gel electrolyte that at least partially fills voids between the solid-state electroactive particle.

9. The electrochemical cell of claim 8, wherein the polymeric gel electrolyte at least partially fills voids between the first solid-state electrolyte particles.

10. The electrochemical cell of claim 1, wherein the solid-state interlayer covers greater than or equal to about 50% to less than or equal to about 100% of a total surface area of a surface of the electrode opposing the solid-state electrolyte layer.

11. The electrochemical cell of claim 1, wherein the solid-state interlayer comprises a plurality of through-holes dispersed therewithin.

12. The electrochemical cell of claim 11, wherein the through-holes have an average diameter greater than or equal to about 0.05 micrometers (µm) to less than or equal to about 100 µm.

13. The electrochemical cell of claim 11, wherein the solid-state interlayer covers greater than or equal to about 50% to less than or equal to about 100% of a total surface area of a surface of the electrode opposing the solid-state electrolyte layer.

14. An electrochemical cell that cycles lithium ions, wherein the electrochemical cell comprises:
a first electrode comprising a plurality of first solid-state electroactive particles;
a second electrode comprising a plurality of second solid-state electroactive particles;
a solid-state electrolyte layer disposed between the first electrode and the second electrode, and
a solid-state interlayer disposed between the first electrode and the solid-state electrolyte layer, the solid-state interlayer comprising a plurality of first solid-state electrolyte particles, and the solid-state interlayer having a thickness greater than or equal to about 0.1 micrometers (µm) to less than or equal to about 8 µm.

15. The electrochemical cell of claim 14, wherein the solid-state interlayer is a first solid-state interlayer and the electrochemical cell further comprises:
a second solid-state interlayer disposed between the second electrode and the solid-state electrolyte layer, the second solid-state interlayer comprising a plurality of second solid-state electrolyte particles, and the second solid-state interlayer having a thickness greater than or equal to about 0.1 micrometers (µm) to less than or equal to about 8 µm.

16. The electrochemical cell of claim 15, wherein the first and second solid-state electrolyte particles are independently selected from the group consisting of: Li₁₊ₓAlₓTi₂₋ₓ(PO₄)₃, where 0 ≤ x ≤ 2 (LATP Li₂₊₂ₓZn₁₋ₓGeO₄ (where 0 < x < 1), Li₁₄Zn(GeO₄)₄,), Li₇La₃Zr₂O₁₂, Li_{6.2}Ga_{0.3}La_{2.95}Rb_{0.05}Zr₂O₁₂, Li_{6.85}La_{2.9}Ca_{0.1}Zr_{1.75}Nb_{0.25}O₁₂, Li₂₊₂ₓZn₁₋ₓGeO₄ (where 0 < x < 1), Li₁₄Zn(GeO₄)₄, Li_{3.3}La_{0.53}TiO₃, LiSr_{1.65}Zr_{1.3}Ta_{1.7}O₉, Li_{2x-y}Sr₁₋ₓTa_{y}Zr_{1-y}O₃ (where x = 0.75y and 0.60 < y < 0.75), Li₁₊ₓAlₓGe₂₋ₓ(PO₄)₃ (where 0 ≤ x ≤ 2) (LAGP), Li_{1.4}Al_{0.4}Ti_{1.6}(PO₄)₃, Li_{1.3}Al_{0.3}Ti_{1.7}(PO₄)₃, LiTi₂(PO₄)₃, Li₃N, Li₇PN₄, LiSi₂N₃, LiI, Li₃InCl₆, Li₂CdCl₄, Li₂MgCl₄, LiCdI₄, Li₂ZnI₄, Li₃OCl, Li₃YCl₆, Li₃YBr₆, Li₂B₄O₇, Li₂O—B₂O₃—P₂O₅, and combinations thereof.

17. The electrochemical cell of claim 15, further comprising:
a polymeric gel system at least partially fills voids between the first solid-state electroactive particles, the first solid-state electrolyte particles, the second solid-state electroactive particles, and the second solid-state electrolyte particles.

18. The electrochemical cell of claim 15, wherein the first solid-state interlayer covers greater than or equal to about 50 % to less than or equal to about 100 % of a total surface area of a surface of the first electrode opposing the solid-state electrolyte layer, and
wherein the second solid-state interlayer covers greater than or equal to about 50% to less than or equal to about 100% of a total surface area of a surface of the second electrode opposing the solid-state electrolyte layer.

19. The electrochemical cell of claim 15, wherein at least one of the first and second solid-state interlayers comprises a plurality of through-holes dispersed therewithin, wherein the through-holes have an average diameter greater than or equal to about 0.05 micrometers (µm) to less than or equal to about 100 µm.

20. The electrochemical cell of claim 14, wherein the solid-state electrolyte layer is a free-standing membrane defined by a polymeric gel, wherein the free-standing membrane has a thickness greater than or equal to about 5 micrometers (µm) to less than or equal to about 200 µm.
